(19) United States
(12) Patent Application Publication
(10) Pub. No.: US 2020/0050638 A1
(43) Pub. Date: Feb. 13, 2020

(54) SYSTEMS AND METHODS FOR ANALYZING THE VALIDITY OR INFRINGMENT OF PATENT CLAIMS

(71) Applicant: Parker Douglas Hancock, Houston, TX (US)

(72) Inventor: Parker Douglas Hancock, Houston, TX (US)

(21) Appl. No.: 16/538,065

(22) Filed: Aug. 12, 2019

Related U.S. Application Data
(60) Provisional application No. 62/717,875, filed on Aug. 12, 2018.

(51) Int. Cl. G06F 16/9032; G06F 17/27; G06F 16/901; G06F 16/903

(52) U.S. Cl. CPC G06F 16/90332; G06F 17/277; G06F 16/90344; G06F 17/2795; G06F 16/901; G06F 17/2775

(57) ABSTRACT

The present invention relates to systems and methods for determining the validity or infringement of a patent claim using natural language processing and information retrieval techniques. Embodiments of the disclosed technology include methods for analyzing whether a plurality of references describe a limitation of a patent claim by a computing device by indexing the plurality of references to create a plurality of search documents, building a search index from the plurality of search documents, generating a query from the limitation, executing a search in the search index for search documents that match the query, and outputting a result, comprising a search document that matches the query and a score representing a relevancy of the search document to the query

### TECHNICAL FIELD

The present invention relates to systems, methods, and computer readable storage media containing instructions for determining the validity or infringement of a patent using natural language processing and information retrieval techniques.

### BACKGROUND

The day-to-day life of a patent attorney is frequently filled with reviewing voluminous prior art references or reams of documentary evidence to determine whether a patent is valid or infringed. Such work can often be tedious. For validity purposes, each prior art reference must carefully reviewed, and compared to the scope of each and every limitation in a patent claim. For infringement, a stack of evidence must be scoured for proof that the alleged infringer practices each and every limitation of each and every claim. This process often requires the taking of voluminous notes, and is extremely time-consuming.

Patent attorneys are also often presented with strategic considerations to determine which claims they should assert against a potential infringer (either in litigation or for licensing purposes). The goal is often to assert the broadest claim which is not invalid. Careful study of the prior art may suggest that the broadest claims of a patent are likely invalid, and therefore a narrower claim should be asserted. Again, the careful balancing of the strength of an infringement argument and the risk of invalidity can be time-consuming and tedious.

Likewise, patent attorneys are often presented with tasks that include evaluating whether various instrumentalities and methods infringe certain claims, such as in pre-lawsuit analysis, or look for weaknesses in patent claims, such as in freedom-to-operate analysis. Prior to filing patent applications (or after filing), patent attorneys are often asked to analyze whether a given invention is potentially patentable (e.g. a patentability analysis). Each of the analyses given above all include comparing the claims of a patent (or patent application) to the prior art, or to documentation explaining how an instrumentality or method works or operates.

What is needed, therefore, is a method for guiding these inquiries to focus on the most relevant prior art and the most relevant evidence of infringement or noninfringement. Systems and methods are described herein for accomplishing this and other purposes.

### SUMMARY

Some embodiments of the present disclosed technology relate to methods for analyzing whether a reference describes a limitation of a patent claim by a computing device. In some embodiments, the method comprises indexing the reference to create a plurality of search documents, building a search index from the plurality of search documents, generating a query from the limitation, executing a search in the search index for search documents that match the query, and outputting a result, comprising a search document that matches the query and a relevancy score representing a relevancy of the search document to the query.

In some embodiments, indexing the reference further comprises splitting the reference into a plurality of lexical units, and creating a search document that contains a set of fewer than all lexical units in the reference. In some embodiments, creating a search document that contains fewer than all the lexical units in the reference further comprises generating a citation for each search document that refers to the location within the reference of the set of the fewer than all lexical units in the reference. In some embodiments, generating a query further comprises modifying the limitation by removing a word or phrase from the limitation and substituting a word or phrase appearing in an earlier limitation, corresponding specification, or technical thesaurus. In some embodiments, the method further comprises outputting a chart that contains the limitation, and a citation corresponding to the location of the matching search document within the reference. In some embodiments, outputting a result further comprises outputting a plurality of highlighted portions of the search document that matches the query, the method further comprising outputting a chart that contains the limitation, and a summary of the matching search document, wherein the summary of the matching search document is prepared by connecting the highlighted portions of the search document in the order they appear in the search document. In some embodiments, the method further comprises selecting the reference from a plurality of references by executing a second query in a search engine containing the plurality of references, wherein the second query comprises a keyword extracted from a claim containing the limitation.

Some embodiments of the disclosed technology relate to a system for determining where in a plurality of references a limitation of a patent claim is described by a computing device. In some embodiments, the system comprises one or more memories having computer readable computer instructions, and one or more processors for executing the computer readable computer instructions to perform a method comprising indexing the reference to create a plurality of search documents, building a search index from the plurality of search documents, generating a query from the limitation, executing a search in the search index for search documents that match the query, and outputting a result, comprising a search document that matches the query and a relevancy score representing a relevancy of the search document to the query.

In some embodiments indexing the reference further comprises splitting the reference into a plurality of lexical units and creating a search document that contains a set of fewer than all lexical units in the reference. In some embodiments creating a search document that contains fewer than all the lexical units in the reference further comprises generating a citation for each search document that refers to the location within the reference of the set of the fewer than all lexical units in the reference. In some embodiments generating a query further comprises modifying the limitation by removing a word or phrase from the limitation and substituting a word or phrase appearing in an earlier limitation, corresponding specification, or technical thesaurus. In some embodiments, the system further comprises outputting a chart that contains the limitation, and a citation corresponding to the location of the matching search document within the reference. In some embodiments outputting a result further comprises a plurality of highlighted portions of the search document that matches the query, the method further comprising outputting a chart that contains the limitation, and a summary of the matching search document, wherein the summary of the matching search document is prepared by connecting the highlighted portions of the search document in the order they appear in the search document. In some embodiments, the system further comprises selecting the reference from a plurality of references by executing a second query in a search engine containing the plurality of references, wherein the second query comprises a keyword extracted from a claim containing the limitation.

Some embodiments of the disclosed technology relate to a non-transitory computer-readable storage medium containing machine-readable computer instructions that, when executed by a processing device, perform a method of determining where in a plurality of references a limitation of a patent claim is described by a computing device, the method comprising indexing the reference to create a plurality of search documents, building a search index from the plurality of search documents, generating a query from the limitation, executing a search in the search index for search documents that match the query, and outputting a result, comprising a search document that matches the query and a relevancy score representing a relevancy of the search document to the query.

In some embodiments, the instructions on The one or more non-transitory computer-readable storage medium comprise instructions for splitting the reference into a plurality of lexical units, and creating a search document that contains a set of fewer than all lexical units in the reference. In some embodiments, the instructions on The one or more non-transitory computer-readable storage medium comprise instructions for creating a search document that contains fewer than all the lexical units in the reference, and further comprises generating a citation for each search document that refers to the location within the reference of the set of the fewer than all lexical units in the reference. In some embodiments, the instructions on The one or more non-transitory computer-readable storage medium for generating a query further comprise instructions for modifying the limitation by removing a word or phrase from the limitation and substituting a word or phrase appearing in an earlier limitation, corresponding specification, or technical thesaurus. In some embodiments, The one or more non-transitory computer-readable storage medium contains instructions for outputting a chart that contains the limitation, and a citation corresponding to the location of the matching search document within the reference. In some embodiments, the instructions on The one or more non-transitory computer-readable storage medium for outputting a result further comprises instructions to output a plurality of highlighted portions of the search document that matches the query, and further includes instructions for outputting a chart that contains the limitation, and a summary of the matching search document, wherein the summary of the matching search document is prepared by connecting the highlighted portions of the search document in the order they appear in the search document. In some embodiments, The one or more non-transitory computer-readable storage medium contains instructions for selecting the reference from a plurality of references by executing a second query in a search engine containing the plurality of references, wherein the second query comprises a keyword extracted from a claim containing the limitation.

### BRIEF DESCRIPTION OF THE FIGURES

Included in the present specification are figures which illustrate various embodiments of the present disclosed technology. As will be recognized by a person of ordinary skill in the art, actual embodiments of the disclosed technology need not incorporate each and every component illustrated, but may omit components, add additional components, or change the general order and placement of components. Reference will now be made to the accompanying figures and flow diagrams, which are not necessarily drawn to scale, and wherein:

FIG. 1 depicts a computing device in accordance with embodiments.

FIG. 2 depicts a cloud computing environment in accordance with embodiments.

FIG. 3 depicts an example system architecture in accordance with embodiments.

FIG. 4 depicts the internal structure and organization of a reference search module in accordance with embodiments.

FIG. 5 depicts the internal structure and organization of an indexer module in accordance with embodiments.

FIG. 6 depicts the internal structure and organization of a query generator module in accordance with embodiments.

FIG. 7 depicts the internal structure and organization of a search engine module in accordance with embodiments.

FIG. 7A depicts example architectures of Word2Vec neural networks in accordance with embodiments.

FIG. 7B depicts and example architecture of a transformer network in accordance with embodiments.

FIG. 8 depicts the internal structure and organization of a report generator module in accordance with embodiments.

FIG. 9 depicts a report showing relevancy scores for each limitation for each reference in accordance with embodiments.

FIG. 10 depicts a report showing relevancy scores for combinations of references in accordance with embodiments.

FIG. 11 depicts a report showing a reference compared to the claims of a patent, along with a summary of the reference, in accordance with embodiments.

FIG. 12 depicts a report showing a reference compared to the claims of a patent in accordance with embodiments

FIG. 13 is a flowchart of a method in accordance with embodiments

### DETAILED DESCRIPTION

The following detailed description is directed to systems, methods, and computer-readable media for comparing one or more references to the limitations of a patent claim, among other purposes.

Although example embodiments of the present disclosure are explained in detail, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Moreover, titles or subtitles may be used in this specification for the convenience of a reader, which shall have no influence on the scope of the present disclosure.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose.

It is to be understood that the mention of one or more steps of a method does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

In the following detailed description, references are made to the accompanying drawings that form a part hereof and that show, by way of illustration, specific embodiments or examples. In referring to the drawings, like numerals represent like elements throughout the several figures.

Various products and services provided by third parties are mentioned as example components of embodiments in accordance with the disclosed technologies. The use of trademarked (registered or common-law) names are intended for descriptive purposes only—no claim of ownership over the terms is asserted by the applicants. Further, the mention of a trademarked product or service is as an example only. Other products and services providing equivalent functions, whether commercial, open-source, or custom-developed to support embodiments are contemplated in accordance with the disclosed technology.

The term “reference” as used herein refers to any form of information storage containing text. Non-limiting examples of references include published patents and published patent applications, from the United States Patent & Trademark Office, the World Intellectual Property Organisation, or other national, intergovernmental, regional, or international intellectual property authority. References need not be prior art and can instead be documents describing or illustrating a device or instrumentality accused of infringement, or a device or instrumentality that a potential applicant wishes to obtain patent protection for. Other non-limiting examples of references can also include academic journal articles, websites, emails, books, memoranda, presentations, product documentation, and others. References can contain textual information, whether in English or any other language.

The term “patent” as user herein refers to any issued patent, published patent application, publicly-available patent application, either in the US or elsewhere, or any other document containing one or more claims, whether in English or any other language.

The term “lexical unit” refers to an organized unit of human language. Non-limiting examples of lexical units include letters, words, phrases, sentences, paragraphs, pages, sections, chapters, and books.

The term “limitation” refers to a portion of a patent claim. A limitation can be a specific limitation of a claim in a patent document (e.g. as set off by tabs, commas, or semicolons), or can be a subdivision of a claim as divided by embodiments in accordance with the disclosed technology. Further, some claims, including but not limited to short dependent claims, can comprise only a single limitation.

The term “structured data” refers to electronic data stored in an organized manner other than plain text, and including metadata. Non-limiting examples of structured data include Javascript Object Notation (JSON), eXtensible Markup Language (XML), HyperText Markup Language (HTML), and other derivates thereof (e.g. OpenOffice XML formats, such as .docx, .pptx, .xlsx). Structure data can also include binary data formats, such as Protocol Buffers (protobuffs), binary JSON (B SON) and other similar data types. Structured data also refers to any other similar data format, either now-known or later-developed.

The term “PDF” refers to the Adobe Portable Document Format, in any version. It should be noted that the PDF format is a container format that can hold information in other formats, including images, plain text, and structured data.

The term “stop words” or “stop phrases,” both of which are used interchangeably, are words which can be filtered out before or after processing of natural language data. Any group of words can be chosen as the stop words for a given purpose. For some search engines, these are some of the most common, short words, in a particular language. In English, stop words include such words as “the”, “is”, “at”, “which”, and “on”. Stop words and stop phrases can be specific to a language, or to a specific kind of textual documents, like patent documents. For example, the phrases “the method of Claim #” or “comprising” or “wherein” may be suitable stop words for parsing patent claims, because they appear with great frequency, and do not contribute significantly to the lexical meaning of the claim language for the purpose of determining whether a reference includes claim language containing those phrases.

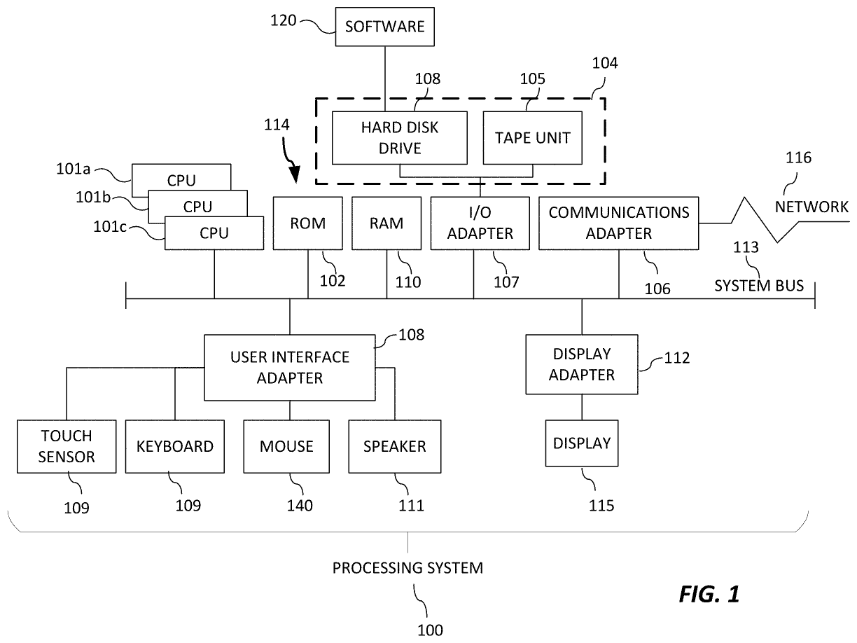

Referring now to FIG. 1, there is shown an embodiment of a processing system 100 for implementing the teachings herein. In this embodiment, the processing system 100 has one or more central processing units (processors) 101a, 101b, 101c, etc. (collectively or generically referred to as processor(s) 101). Processors 101, also referred to as processing circuits, are coupled to system memory 114 and various other components via a system bus 113. Read only memory (ROM) 102 is coupled to system bus 113 and may include a basic input/output system (BIOS), which controls certain basic functions of the processing system 100. The system memory 114 can include ROM 102 and random access memory (RAM) 110, which is read-write memory coupled to system bus 113 for use by processors 101.

FIG. 1 further depicts an input/output (I/O) adapter 107 and a network adapter 106 coupled to the system bus 113. I/O adapter 107 may be a small computer system interface (SCSI) adapter that communicates with a hard disk (magnetic, solid state, or other kind of hard disk) 103 and/or tape storage drive 105 or any other similar component. I/O adapter 107, hard disk 103, and tape storage drive 105 are collectively referred to herein as mass storage 104. Software 120 for execution on processing system 100 may be stored in mass storage 104. The mass storage 104 is an example of a tangible storage medium readable by the processors 101, where the software 120 is stored as instructions for execution by the processors 101 to implement a circuit and/or to perform a method, such as those shown in FIGS. 1-7 and 10-11. Network adapter 106 interconnects system bus 113 with an outside network 116 enabling processing system 100 to communicate with other such systems. A screen (e.g., a display monitor) 115 is connected to system bus 113 by display adapter 112, which may include a graphics controller to improve the performance of graphics intensive applications and a video controller. In one embodiment, adapters 107, 106, and 112 may be connected to one or more I/O buses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 140, and speaker 111 can be interconnected to system bus 113 via user interface adapter 108, which may include, for example, a Super I/O chip integrating multiple device adapters into a single integrated circuit.

Thus, as configured in FIG. 1, processing system 100 includes processing capability in the form of processors 101, and, storage capability including system memory 114 and mass storage 104, input means such as a keyboard 109, mouse 140, or touch sensor 109 (including touch sensors 109 incorporated into displays 115), and output capability including speaker 111 and display 115. In one embodiment, a portion of system memory 114 and mass storage 104 collectively store an operating system to coordinate the functions of the various components shown in FIG. 1.

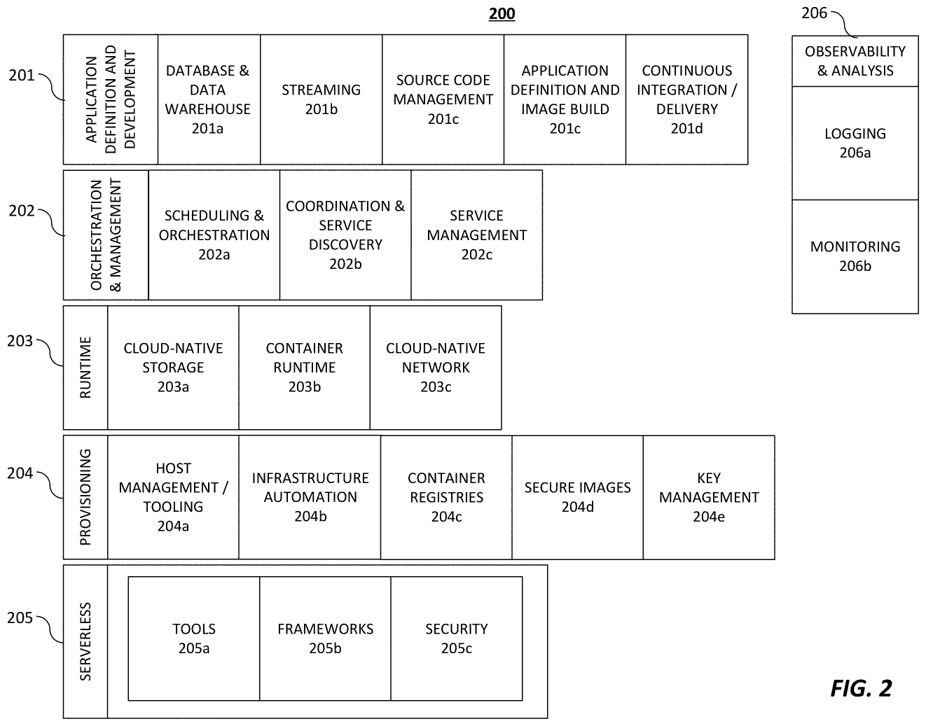

Embodiments of the present technology can also be implemented using cloud-based technologies, such as those depicted in FIG. 2. Cloud native technologies include scalable applications in modern, dynamic environments such as public, private, and hybrid clouds. Containers, service meshes, microservices, immutable infrastructure, and declarative APIs exemplify this approach. These techniques enable loosely coupled systems that are resilient, manageable, and observable.

Embodiments of the disclosed technology can be built using one or more elements of cloud computing technology as shown in FIG. 2. Cloud technologies can include application definition and development tools 201, orchestration & management tools 202, runtime tools 203, provisioning tools 204, serverless components 206, and observability & analysis tools.

Application definition and development components 201 (“ADD”) enable developers to define and develop applications prior to deployment, and to refine those designs in subsequent versions. ADD components 201 can include database and data warehouse components 201a that provide data sets and data storage for application development. These database and data warehouse components 201a include relational and non-relational data stores, graph databases, flat files, and other data storage technologies. ADD components 201 can further include streaming components 201b that facilitate rapid distribution of data to numerous system endpoints, such as message queues, stream processing software, and other data distribution systems. ADD components 201 can further include source code management components 201c, such as Git, Mercurial, Subversion, and other similar source management systems. Source code management components 201c can also include cloud-based servers for version control, such GitHub or GitLab. ADD components 201 can further include application definition and image build components 201c that allow developers to define cloud-based infrastructure, including configurations of application servers, software defined networks, and containerized services. ADD components 201 can further include continuous integration and continuous delivery (CI/CD) components 201d that automate the process of application testing and deployment. CI/CD components 201d can be configured to automatically run automated tests on application software (e.g. such as when a change is committed to a version control platform), and if the tests are successful, to deploy the application software to a production environment.

Orchestration and management (“OM”) components 202 facilitate the containerization and subsequent coordinated execution of application software. OM components 202 include scheduling and orchestration components 202a that schedule and run containerized software. Non-limiting examples of scheduling and orchestration components 202a include Kubernetes and Docker Swarm. OM components 202 can further include coordination and service discovery components 202b that allow software to automatically discover cloud-based resources, such as data stores, data streaming sources, etc. OM components can further include service management components 202c that can include load balancers, reverse proxy systems, auto scalers, and other components that facilitate autonomous or manual application scaling.

Runtime components 203 can include basic environments for the support execution of cloud-based application software. Runtime components 203 can include cloud-native storage 203a, such as object stores, virtual file systems, block storage, and other forms of cloud-centric data storage. Runtime components 203 can include container runtimes 203b that provide the foundation for containerized application software, such as Docker or Rkt. Runtime components 203 can further include cloud-native network components 203c that provide software-defined networking and virtual private cloud technologies that enable components of cloud-based systems to communicate with each other, as well as with the wider Internet.

Provisioning components 204 can include components intended for configuring cloud components and triggering the creation of cloud resources on various cloud platforms. Provisioning components can include Host Management and Tooling components 204a that define and deploy configurations of cloud components when executed. Provisioning components 204 can further include infrastructure automation components 204b that automate basic cloud infrastructure tasks. Provisioning components 204 can further include container registries 204c that provide storage for containerized cloud applications that are deployable by other provisioning components. Provisioning components can further include secure image components 204d that provide security and verification for container images to ensure consistent and reliable deployment of trusted container images. Provisioning components can further include key management systems 204e that provide for secure storage of cryptographic keys.

Serverless components 205 can include components for deploying cloud applications that do not rely upon a continuously-running (or scheduled) runtime execution, but instead run discrete components of functionality given a condition. Serverless components 205 can include components 205a to simplify the development of serverless applications, such as components that convert server-centric software into serverless code, event simulators, and simulations of cloud-based serverless platforms. Serverless components 205 can also include frameworks 205b that are predefined systems that take code in certain configurations and deploy them as serverless applications in cloud environments. Serverless components 205 can also include security components 205c that help to secure serverless applications.

Observability & Analysis components (“O&A”) 206 can include systems for monitoring running cloud applications, detecting and observing defects and errors, and logging system performance. O&A components 206 can include monitoring components 206a that monitor running systems to display and/or record performance metrics, error rates, and other application data. O&A components 206 can also include logging components 206b that collect system logs from cloud-based components and aggregate them in a single place or to a single access point to review system performance. O&A components 206 can also include tracing components 206c that collect detailed trace logs when cloud components run into errors, system exceptions, and other problematic behaviors to assist in the identification and remediation of problems in cloud-based systems.

In some embodiments, one or more methods are embodied in a set of instructions for one or more processors having access to one or more types of memory. The instructions could be coded in hardware or in software. Many kinds of platforms may be used, including but not limited to: computers, mobile telephones, tablet devices, game consoles, network management devices, field-programmable gate arrays, and cloud-based computer systems. Aspects of the disclosure could be deployed on multiple devices for concurrent operation. Embodiments may be used as a component of a larger system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In some embodiments, the computer readable medium can be a non-transitory storage system on a cloud platform, such as, for example, in a database or data warehouse component 201a, a source code management tool 201c, cloud-native storage component 203a, embodied in a container image stored locally or in a container registry 204c, or deployed in a container runtime 203b. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including languages such as Java, Python, Go, Ruby, Javascript, Smalltalk, C++ or the like. As defined herein, computer program code also includes the build artifact of an of the above languages, or similar languages and environments, such as object code, byte- or word-code, or other compiled, interpreted, or processed code. The program code may execute entirely on the user's computer, partly on the user's computer, as a stand-alone software package, partly on the user's computer and partly on a remote computer or entirely on one or more remote computers, servers, or serverless cloud platforms. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments of the present invention that are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The disclosed technology is disclosed in terms of modules and submodules, each of which are to be understood as discrete units of functionality, which can be embodied as classes, modules, functions, compilation or build artifacts, or other components of one or more programming languages used to implement embodiments of the disclosed technology. While the present description illustrates one organization of the various modules and submodules for implementing embodiments of the disclosed technology, the invention is not so limited. Embodiments of the present disclosed technology can include other organizations for implementing equivalent or overlapping functionality for the various modules described herein, such as by sharing functionality between modules, combining modules, separating modules into multiple modules, implementing class hierarchies and the like. Additionally, the accompanying drawings illustrate example relationships between various modules and submodules (such as by flowchart connectors or inclusion of modules as sub-modules of other modules), but these relationships are not limiting. As would be recognized by a person of ordinary skill in the art, the output of any given module is available to be included as part of the input of any other component in accordance with various embodiments.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Technical effects and benefits include providing detailed reports and documentation to facilitate the examination and evaluation of various invalidity, patentability, or infringement analyses.

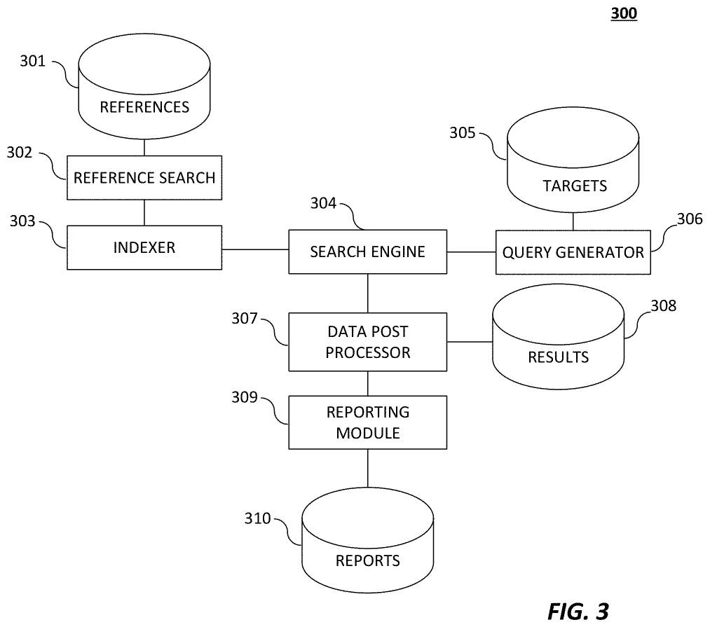

FIG. 3 depicts a system 300 in accordance with an embodiment of the disclosed technology. The system can include a source of references 301 that provides a plurality of references that can be searched. The system 300 can include a reference search module 302 that selects one or more references from the source of references 301. The selected references can comprise one or more computer-readable documents containing text. The system 300 can include an indexer module 303 that processes selected references to produce one or more search documents for inclusion in a search engine 304. In some embodiments, one or more references can be provided directly to the indexer 303 for inclusion in search engine 303, for example, the results of a manual prior art search, references cited during prosecution, product documentation for an accused instrumentality or a prospective patentable invention.

The system 300 can include a source of targets 305 that comprises at least a limitation of a patent. As a non-limiting example, the source of targets can be a computer-readable database of patent documents, such as, for example, a USPTO database or web-accessible Application Programming Interface (API). The system can include a query generator 306 that processes the target information from the source of targets 305 to produce queries suitable for execution by a search engine 304. In some embodiments, the query generator 306 can perform natural language processing on the claim language, specification, and/or figures of a targeted patent to produce queries that are representative of claims or limitations of patent claims.

The system 300 can further include a search engine 304 which processes a query from the query generator 306 to produce a result. The result of the search engine 304 can comprise a set of documents or references to documents that correspond to a query. The result of search engine 304 can further include a relevancy score that indicates how relevant the search document was to the search query. In some embodiments, the result of the search engine 304 can also include a highlight, that is, a portion of the text of the search document that matched the query. In some embodiments, the result of the search engine 304 can also include a maximum relevancy score as a result of a query, representing the relevancy score of the most relevant search document in the query results.

The system 300 can further include a data post-processor 307 that processes the results of search engine 304. The post-processor can filter and/or format the results of the search engine to be suitable for either storage in a results database 308, or for further processing by a reporting module 309. The data post-processor can modify the results of the search engine 304 by extracting components of the result (e.g. the maximum score, the text of the top five hits, etc.), or applying transformations (e.g. calculating the average or weighted trailing average of the top n search results).

The system 300 can further include a reporting module 309 that can process the results of search engine 304 directly, or as further processed by data post-processor 307. The reporting module can produce reports for human review of the results of the system. Reports can include spreadsheets, database entries, textual charts, html documents, or other types of reports.

The system 300 is an example of an architecture of a system in accordance with the disclosed technology. However, as would be recognized by a person of ordinary skill, other architectures could be implemented to perform substantially the same functionality. Further, as described herein, not every module need be present in accordance with the disclosed technology. For example, the reference searcher may be omitted and a manually-collected set of references can be provided to the indexer. Further, each component described above is described in further detail below. For ease of explanation, the wide variety of functions that comprise the disclosed technology is broken down into modules and sub-modules. As would be recognized by a person of ordinary skill in the art, equivalent systems can be designed by re-organizing the location of each function, submodule, and module, or by incorporating related submodules into a separate shared module, without departing from the scope of the disclosed technology.

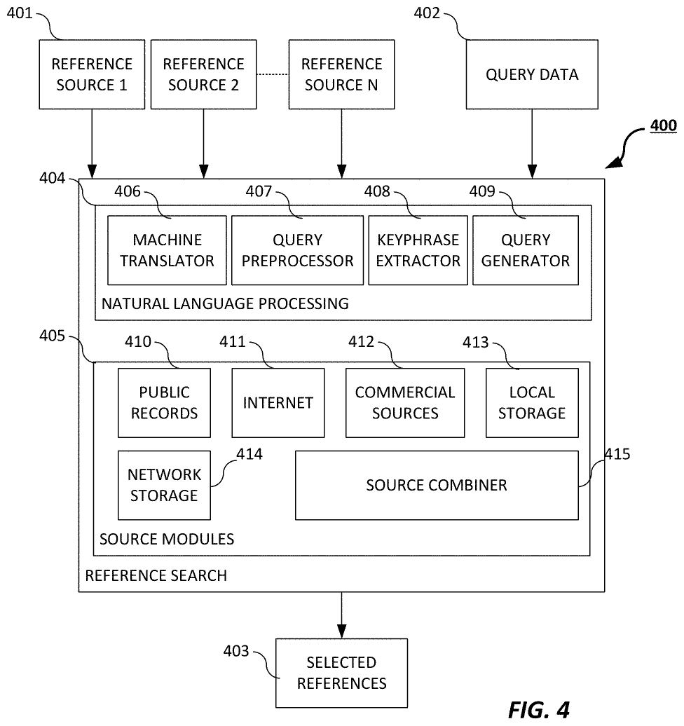

FIG. 4 depicts a reference search module 400 in accordance with an embodiment. An example reference search module 400 takes as input one or more reference sources 401, and some query data 402, and produces a set of selected references 403. The reference sources 401 can be any computer-readable source of data. Non-limiting examples of such sources includes a local or network database (relational or non-relational databases), local or network file storage, websites, or web-based API's. The reference search module 400 also obtains query data 402. Query data 402 can comprise any textual data. Non-limiting examples of query data 402 can include one or more limitations from a claim of a targeted patent, the specification of a target patent or a component thereof (e.g. an abstract, summary, detailed description, etc.), or other portion thereof, a user-defined search phrase or sentence, or any other form of data related to a targeted patent or patent claim or limitation.

The reference search module can comprise a natural language processing module 404 and a set of source modules 405. The natural language processing module 404 can convert the query data into a well-formed query. The natural language processing module can comprise a machine translation module 406, query preprocessor 407, a keyphrase extractor 408, and a query generator 409.

The machine translation module 406 of the natural language processing module 406 optionally transforms the query data and/or references from reference sources from a first language into a second language. The machine translation module 406 is used where a particular reference source 401 includes references that are in a different language than the query data. In some embodiments, a single reference source 401 can contain documents in more than one language, and the process implemented by reference search module 400 can be repeated for each language in the reference source 401 to produce a set of selected references 403. Embodiments of the disclosed technology can include similar machine translation modules at various points, including as part of the reference search module 302, index 303, search engine 304, query generator 306, and/or the reporting module 309. Each machine translation module (or the use of the same module by various other modules) can translate a portion of text in a first language to a second language. Machine translation at any point can be accomplished using rule-based translation, statistical translation, hybrid translation, or neural network translation methodologies.

Rule-based machine translation (RBMT; “Classical Approach” of MT) is machine translation systems based on linguistic information about source and target languages basically retrieved from (unilingual, bilingual or multilingual) dictionaries and grammars covering the main semantic, morphological, and syntactic regularities of each language respectively. Having input sentences (in some source language), an RBMT system generates them to output sentences (in some target language) on the basis of morphological, syntactic, and semantic analysis of both the source and the target languages involved in a concrete translation task.

Statistical machine translation (SMT) is a machine translation paradigm where translations are generated on the basis of statistical models whose parameters are derived from the analysis of bilingual text corpora. The statistical approach contrasts with the rule-based approaches to machine translation as well as with example-based machine translation.

Hybrid machine translation is a method of machine translation that is characterized by the use of multiple machine translation approaches within a single machine translation system. The motivation for developing hybrid machine translation systems stems from the failure of any single technique to achieve a satisfactory level of accuracy. Many hybrid machine translation systems have been successful in improving the accuracy of the translations, and there are several popular machine translation systems which employ hybrid methods.

Neural machine translation (NMT) is an approach to machine translation that uses a large artificial neural network to predict the likelihood of a sequence of words, typically modeling entire sentences in a single integrated model. NMT departs from phrase-based statistical approaches that use separately engineered subcomponents. Neural machine translation (NMT) uses vector representations (“embeddings”, “continuous space representations”) for words and internal states. The structure of the models is simpler than phrase-based models. There is no separate language model, translation model, and reordering model, but just a single sequence model that predicts one word at a time. However, this sequence prediction is conditioned on the entire source sentence and the entire already produced target sequence. NMT models use deep learning and representation learning. The word sequence modeling was at first typically done using a recurrent neural network (RNN). A bidirectional recurrent neural network, known as an encoder, is used by the neural network to encode a source sentence for a second RNN, known as a decoder, that is used to predict words in the target language.

In some embodiments, the machine translation module can be configured to transmit query data to an external system to perform machine translation, such as a network-accessible API.

The reference search module 400 also includes a query preprocess 407 that can perform preprocessing steps on the query data. Preprocessing steps can include conversion of the query data from one data format to another (e.g. ASCII text to Unicode), removal of whitespace or invalid characters, removal of stop words or phrases, and substitution of words or phrases with equivalent words or phrases. The equivalent words or phrases can be synonyms in the language of the query to be generated, technical terms that are substituted with equivalent or broader technical terms, and terms defined elsewhere in the query data.

The reference search module 400 can include a keyphrase extractor 408 which performs keyword extraction on the query data. In some embodiments, the query data can be unnecessarily lengthy, such as the entirety of a patent claim set or a complete specification. The keyphrase extractor module performs keyword extraction to produce a list of the most significant words and/or phrases within the preprocessed query data.

Embodiments of the disclosed technology can take advantage of any keyword extraction technology now-known or later-developed. Keyword extraction generally is the task of automatically identifying a set of terms that best describe the subject of a document. Some embodiments can employ a taxonomy-based keyword extraction method. In such a method, a segment of text is analyzed to determine whether it matches one or more of a predefined set of keywords. Some embodiments can employ a keyword extraction technique that identifies words or phrases within a text that are most significant, by some measure. A specific example of a keyword extraction technology in accordance with an embodiment is “Rapid Automatic Keyword Extraction” (RAKE) as described in U.S. Pat. No. 8,131,734, entitled “Rapid automatic keyword extraction for information retrieval and analysis,” the entirety of which is incorporated by reference as if fully set forth herein. As would be recognized by persons of ordinary skill in the art, other keyword extraction methods can be used.

The reference search module 400 can further include a query generator 409 that produces a query to be performed against the reference sources 401. The query generator 409 can take the list of key phrases from the keyphrase extractor 408 and produce a well-formed search query using the key phrases. The process of generating the query can include concatenating the top number or percentage of key words and phrases, or the top number or percentage of key words and phrases having a length greater than a predetermined minimum length, or a length smaller than a predetermined maximum length. In some embodiments, the query generator 409 can concatenate the extracted keyphrases or a subset thereof with boolean connectors (e.g. “AND” or “OR”) to form a search query.

The reference search module 400 can further include a set of source modules 405 for handling the unique aspects of various data sources. Examples of search modules include modules for public records 410, the internet and various internet search engines 411, commercial sources and databases 412, local storage files and databases 413, and network storage files and databases 414. Each search module includes functionality for accessing a particular reference source, converting the query generated by the query generator into an appropriate query for the data source, executing the query against the reference source, and returning a set of matching references. For some source modules, the query result can also include returning the set of matching references in relevance order, or returning a relevancy score or metric along with at least one of the matching references. The set of source modules 405 depicted here is merely an example, and does not limit the disclosed technology to any specific set of source modules. Further, while the search modules depicted here are generic, example embodiments may have more specific search modules, such as a specific search module for USPTO data, or even a particular kind of USPTO data.

In some embodiments, the query data 402 can comprise metadata relevant to targeted patents, such as the names of inventors, list of assignments and assignees, filing, priority, publication, or issue dates, classification of the targeted patent under any national, cooperative, or international classification scheme, or a field of search for the targeted patent. Source modules 405 can further include modules for obtaining sets of references from various sources corresponding to the metadata. For example, a source module can retrieve all references authored or invented by one or more named inventors on the targeted patent, or all references assigned to a present or past assignee of the targeted patent. In some embodiments, the search module can retrieve a set of references comprising references within the classification or field of search of the targeted patent, or any related or similar classification. In some embodiments, the search module can retrieve a set of references comprising references where one or more of the filing, priority publication, or issue date before, on, or after a targeted date, or within a predefined range of dates. By way of non-limiting example, an embodiment can search for references with a priority date before the priority date of a targeted patent, or within a predetermined time range before the priority date of a targeted patent.

In some embodiments, the query data 402 can comprise priority dates for one or more targeted patents. When a system in accordance with the disclosed technology is used to determine the validity of patent, the references selected 403 by the reference search module 400 can be filtered to include only those references that match a date condition, such as those references that were published or have a priority date of a predetermined duration before or after the priority date of the targeted patent (e.g. published a year before the priority date). The reference search module 400 can perform the filtering either by including the date condition in the query generated by the query generator 409, included in a corresponding source module 410-414, or can be filtered out by the source combiner 415 discussed herein.

In some embodiments, the reference search module 400 can omit search elements such as the query data 402, query preprocessor 407, key phrase extractor 408, and query generator 408, and instead return as selected references 403 all references from reference sources 401.

In some embodiments, the reference search module 400 further includes a source combiner 415 which combines the selected references out of the various source modules to produce a set of selected references 403. In some embodiments, the source combiner can aggregate all the sources produced by each source module 410-414 and return a complete set of references to the indexer. In some embodiments, the source combiner 415 can instead filter out duplicate references obtained from multiples sources. In embodiments of the source combiner 415 that filter out duplicates, the one copy of the reference that remains can be selected based on a preferred source. For example, a reference stored locally can be preferred over a source stored on a network, and public records can be preferred over commercial storage, etc. In some embodiments, the source combiner can return only those sources found in multiple sources. Results found in multiple locations are likely to be more relevant that sources found only in one source or another source. In some embodiments, the source combiner can convert the references from one format to another, such as by applying machine translation, or transforming references in a plurality of data formats into a single data format.

In some embodiments, the source combiner can apply a ranking system, or augment a ranking system from the source submodules. For example, if a submodule or set of submodules returns references with a relevancy ranking score, the source combiner can standardize the ranking score to a common scale. If a submodule or set of submodules returns references in a ranked order, the source combiner can instead spread the ranked references across the common scale in accordance with a function. For example, the ranking of each set of references from each set of source submodules can be normalized to fit within the range 0-1 (or some other interval), according to one of the normalization formulae below:

$${s}_{normalized} = \frac{s}{{s}_{max}}$$

$${s}_{normalized} = \frac{s - {s}_{max}}{{s}_{max} - {s}_{min}}$$

The source combiner can then return a list of selected references from a plurality of sources in ranked order. In some embodiments, the reference search module 400 can be configured only to return the top n results (e.g. 10, 50, 100, 1000), and can use the scores on the common scale to sort the top n results. In some embodiments, the source combiner can further apply a boost to references having a certain characteristic (e.g. are patent documents, are in a particular language, etc.), and multiply the common score by a boost constant.

In embodiments having a source combiner 415, the references selected by the source combiner 403 are returned by the reference search module 400.

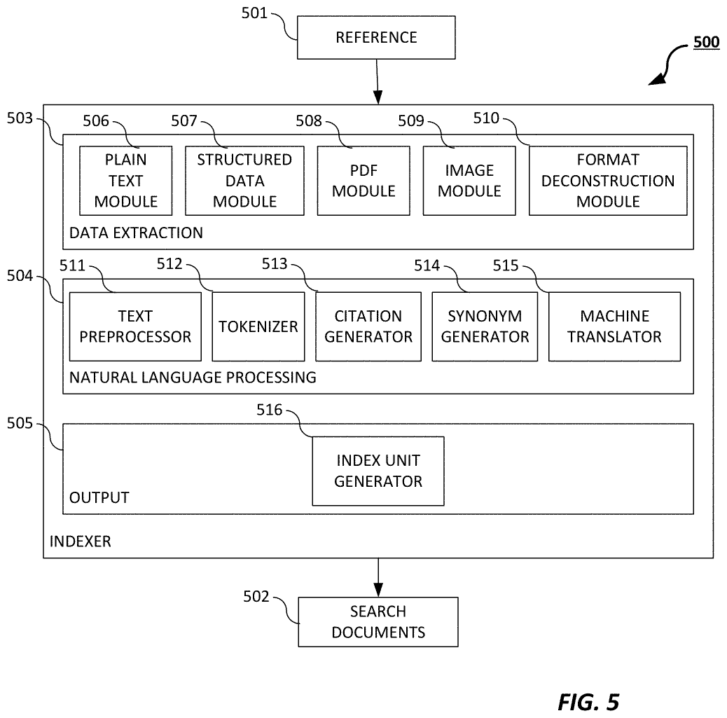

FIG. 5 depicts an indexer module 500 in accordance with the disclosed technology. The indexer 500 can receive one or more references 501 as input, including but not limited to selected references 403 returned by a reference source module 400. The indexer 500 can include a data extraction module 503, a natural language processing module 504, and an output module 505. The data extraction module 503 can convert a reference to a natural language format suitable for natural language processing.

The data extraction module 503 can comprise one or more submodules for processing differing kinds of input data. For example, the data extraction module can have a module for extracting text from plain text 506, structured data 507, PDF files 508, and images 509. The plain text module 506 can read plain text data sources, and return their content. The structured data module 507 can read data encoded in a structured data format and return the text therein. By way of nonlimiting example, the structured data module can take a document stored in a USPTO XML format and extract the text therein, or can take a .docx file (which is just a .zip filled with .xml files according to the OpenOfficeXML standard), and extract the text therein. The PDF module 508 can extract data from PDF documents. The PDF format is a container format which can contain embedded plain text, structured data, and/or images. In some embodiments, the PDF module 508 can inspect a PDF reference, and if the PDF contains embedded text (in plain or structured format), return the embedded text. If the PDF module 508 detects that the PDF does not contain embedded text, the PDF module can perform optical data extraction by breaking the PDF up into constituent images (e.g. images of pages of a document), and providing them to the image module 509. In some embodiments, the indexer can detect that a PDF has embedded text, and perform an optical data extraction process anyway (For example, if the pdf contains images with text not included in the embedded text, or if the embedded text is corrupt or in an undesired format).

In some embodiments, the image module 509 can convert images into text by, for example, performing an optical character recognition (OCR) process. An example of an OCR process in accordance with an embodiment is described in U.S. Pat. No. 7,650,035, entitled “Optical character recognition based on shape clustering and multiple optical character recognition processes,” which is hereby incorporated by reference as if fully set forth herein. While modules 506-509 are provides as example modules for extracting text from references, other such modules could be used and are within the scope of the disclosed technology. For example, separate modules can be provided for extracting text from .xml or .docx or .json files, even though all three are structured data. Likewise, additional modules can be added to process other file formats, including both file formats now existing and later-developed.

The data extraction module 503 also includes a format deconstruction module 510 for converting the output of the various modules 506-609 into a common format for natural language processing. This can include converting the encoding to a common format (e.g. from ASCII to Unicode), removing invalid characters, modifying whitespace (e.g. deleting duplicate spaces or replacing newlines with spaces), converting dual-column text into single-column text, etc.

Some embodiments of the indexer module 503 include a natural language processing module 504. The natural language processing module can include a text preprocessor 511 that processes the text provided by the data extraction module to facilitate other processing steps. This can include performing part-of-speech tagging, keyword extraction, etc. The natural language processing module 504 can further include a tokenizer 512 for splitting the preprocessed text into lexical units. The tokenizer 512 can be configured to split text into a particular type of lexical unit, such as into paragraphs, sentences, components of sentences (e.g. a component of a parsed syntax tree, such as a noun chunk), or words. The tokenizer 512 can be configured to tokenize paragraphs based on the presence of multiple newline characters (“\n\n\”), or indented text (e.g. a newline character followed by one or more tab characters, or physical position of text on a page measured from the left edge, or between subsequent lines). The tokenizer 512 can be configured to tokenize text into sentences. In some embodiments, the tokenizer can tokenize text into sentences based on the presence of sentence terminating punctuation (e.g. !?.), followed by one or two spaces. This can be expressed by the regular expression /[!?\.]\s{1,2}/.

Sentence tokenization can be complicated by the presence of sentence terminating punctuation in non-sentence ending contexts, such as abbreviations or initialisms. For example, the period in English (“.”) is sometimes, but not always, sentence-ending punctuation. This is a particularly difficult problem for legal or scholarly texts that frequently contain citations, which are not separate sentences. For example, the sentence “The Supreme Court of the U.S.A. decided the issue. 25 U.S. 251 (1925)” contains only two sentences, but contains two abbreviations that would cause false-positive detection of a sentence boundary based solely on examination of periods followed by space—the period-space after U.S.A., and the period-space after U.S. An example sentence detection algorithm that improves upon this technique is the Punkt sentence tokenizer described in Tibor Kiss & Jan Strunk, Unsupervised Multilingual Sentence Boundary Detection, 32 Computational Linguistics 485 (2006). This model is based on three observations about the nature of false-positive sentence boundaries caused by abbreviations: (1) abbreviations can be defined as a very tight collocation consisting of a truncated word and a final period, (2) abbreviations are usually short, and (3) abbreviations sometimes contain internal periods.

Punkt sentence tokenization proceeds in two stages. In the first stage, a resolution is performed to detect abbreviation types and ordinary word types. After this stage, the corpus receives an intermediate annotation where all instances of abbreviations detected by the first stage are marked as such with the tag <A> and all ellipses with the tag <E>. All periods following non-abbreviations are assumed to be sentence boundary markers and receive the annotation <S>.

The second, token-based stage employs additional heuristics on the basis of the intermediate annotation to refine and correct the output of the first classifier for each individual token. The token-based classifier is particularly suited to determine abbreviations and ellipses at the end of a sentence giving them the final annotation <A> <S> or <E> <S>. But it is also used to correct the intermediate annotation by detecting initials and ordinal numbers that cannot easily be recognized with type-based methods and thus often receive the wrong annotation from the first stage.

Some embodiments of the indexer module 503 include a citation generator 513 that can generate human-readable citations to tokens produced by the tokenizer. For paginated text, the citation can comprise the page number in an appropriate format (“p. 1”), and can optionally include a paragraph number (e.g. “p.1 ¶ 2”). Alternatively, the citation generator 513 can generate a data representation of a citation, such as a dictionary of citation attributes, e.g. (in JSON format):

| {“citation”: {
| “page”: 1,
| “paragraph”: 2,
| }
| }

Some types of references have standard citation formats. For example, U.S. Patent documents are divided into columns and lines, and are cited by column and line number. Citation formats can include, for column 3, lines 2-5, “col.3, 11.2-5” or “3:2-5” among other formats. As another example, U.S. published patent application documents are typically cited by paragraph number, which can include, for paragraphs 15-20, “[0015]-[0020],” “[0015-0020],” among others. As yet another example, PCT documents are typically cited by page and line number, which can include, for lines 5-6 on page 12, “p.5, 11.5-6” or “12:5-6.” Other documents can use a wide variety of citation formats, such as page and paragraph numbering, page numbering alone, among others.

In some embodiments, the citation generator 513 can generate a data representation that contains the constituent parts of the citation, such as page, paragraph, column, line or other numbering schemes. Storing a data representation can ease generation of final citations in output reports by allowing a group of contiguous search documents to be easily combined into a single citation. For example, if one search document includes the disclosure on column 1, lines 5-10, and another includes the disclosure on column 1, lines 11-20, storing constituent data components can simply the process of generating a final citation “col.1, 11.5-20.” Nevertheless, even if a citation is stored in a human-readable format, human-readable citations can be parsed into data components, and recombined into output citations. For example, the format “5:5-6” can easily be parsed by the regular expression (including python-style named capture groups) as:

### |/(?P<columns>[\d\−]+):(?P<lines>[\d\−]+)/

Some embodiments of the indexer module 503 include a synonym generator 514 that generates a list of relevant synonyms. This list of synonyms can be provided to a search engine to map terms in the search document 502 to a wider set of possible query terms by looking for synonyms for words occurring in search documents.

In some embodiments, synonyms can be generated using a lexical database. Lexical databases contain a list of words in a given language, such as English, with data about the words. The data can comprise one or more of a definition, part of speech, list of synonyms, hypernyms, hyponyms, lemmas of the word, and other similar semantic or lexical data. Lexical databases can contain multiple entries for each word where the same word can have multiple meanings. An example of a lexical database is the Princeton University WordNet database. Princeton University “About WordNet.” WordNet. 2010. available at https://wordnetprinceton.edu/. Where lexical database entries are used, synonyms can be obtained by a synonym module by obtaining the list of synonymns, holonyms, hypernyms, hyponyms, and other similar words from the lexical database. Alternatively, the synonym list can dynamically generate synonyms based on a corpus of text. A common idiom in natural language processing is that a “word is known by the company it keeps.” That is, as text is processed, the synonym module can identify synonyms in the search database by examining the context in which words appear. For example, if the search engine observes search documents containing the following phrases:

TABLE 1
STATISTICAL SYNONYM DETECTION
Sentences
. . . processing chemicals can be stored in a tank prior to use. . .
. . . the related chemicals can be stored in a vessel according to. . .
. . . during the process, the chemicals can be stored
in a cistern and dispensed. . .

The search engine can infer that “tank,” “vessel,” and “cistern,” are synonyms because they frequently occur in similar contexts—e.g. in proximity to the word “chemicals” and as the object of the phrase “can be stored in.” An example of such a statistical synonym detection technique is known as Word2Vec, a machine learning algorithm capa

In some embodiments, statistical synonym detection can be performed on a larger corpus, such as a set of references within a particular field, or classification, or within a reference corpus of text, such as W. N. Francis & H. Kucera, Brown University Standard Corpus of Present-Day American English (1961).

In some embodiments, synonyms can be detected using vector space word embeddings of various terms or phrases within a corpus. A plurality of words within a corpus can be represented as numeric vectors, where each vector represents the collocation of the word with other words in the corpus (e.g. within a window of positions ahead of, or behind the word, within a lexical unit such as a paragraph, sentence, or component of a sentence). For example, the vector representing the word embedding of a target word can have one position (or dimension) for each word or phrase in the corpus, where the value of each position is the total count, relative frequency, or other measure of how frequently that word is collocated with the target word. Synonyms of a target word can then be identified as the group of words within a defined cosine distance from the target word, such as within a threshold, the top n words, or some other measure. Synonyms can be output from the synonym generator 512 and other similar synonym generators in a variety of formats, including but not limited to Apache Solr-style definitions, entries in a lexical database (both discussed infra), or other formats.

Embodiments of the disclosed technology can include synonym generation functionality as part of a variety of modules discussed herein. Each of the synonym and/or synonym list modules can generate synonyms based on the techniques disclosed above.

Some embodiments of the indexer module 503 include a machine translator module 515. The machine translator module can translate the text extracted from one of the data extraction modules 506-509 from a first language into a second language. In some embodiments, the machine translator module can perform translation prior to format deconstruction by the format deconstruction module 510, after the format deconstruction but before text preprocessing 511, or after text preprocessing by the preprocessor 511.

Some embodiments of the indexer module 503 further include an output module 505. The output module 505 can include an index unit generator 516. The index unit generator 516 takes the output of the natural language processing module 504 to produce one or more search documents 502 that correspond to the reference 501. The search documents comprise one or more lexical units from the reference, and can optionally include one or more of a sequence identifier (e.g. a running counter of position of the lexical unit in the reference), a citation to the one or more lexical units, and other metadata related to the reference (e.g. reference title, filing date, reference source, etc.), or the overall task (client matter #, project name, etc). The search document can be represented in a plurality of structured data formats, such as a SQL INSERT command, XML, document, or other structured data format. An example of a search document is shown in JSON format below:

| { “search document: {
| “id”: “US6045364B2”,
| “title”: “Method and apparatus for teaching proper swing tempo”,
| “name”: “Dugan, et al.”,
| “text”: “The present invention relates to an improved method and
| apparatus for teaching proper swing tempo.”
| “citation”: {
| “column_start”: 1,
| “line_start”: 5,
| “column_end”: 1,
| “line_end”: 6
| }
| }

In some embodiments, one or more search documents can be returned by the index unit generator 516 with a separate document and metadata field. An example is shown in JSON below:

| {“search document: {
| “id”: “US6045364B2”,
| “title”: “Method and apparatus for teaching proper swing tempo”,
| “name”: “Dugan, et al.”,
| “search documents:”: [
| {
| “text”: “The present invention relates to an
| improved method and apparatus for teaching proper swing tempo.”
| “citation”: “col. 1, ll.5-6”,
| },
| {
| “text”: “Specifically, acceleration information is
| used as an aid to swing tempo training.”
| “citation”: “col. 1, ll.6-8”,
| },
| ]
| }

The above examples have been shown in a JSON format, but the disclosed technology is not limited to JSON search documents. Search documents can be stored in any structured data format, including XML, or stored in a relational or nonrelational database, or not stored in a non-transitory medium at all and handed directly to search engine 700, such as by passing a reference to memory containing one or more search documents.

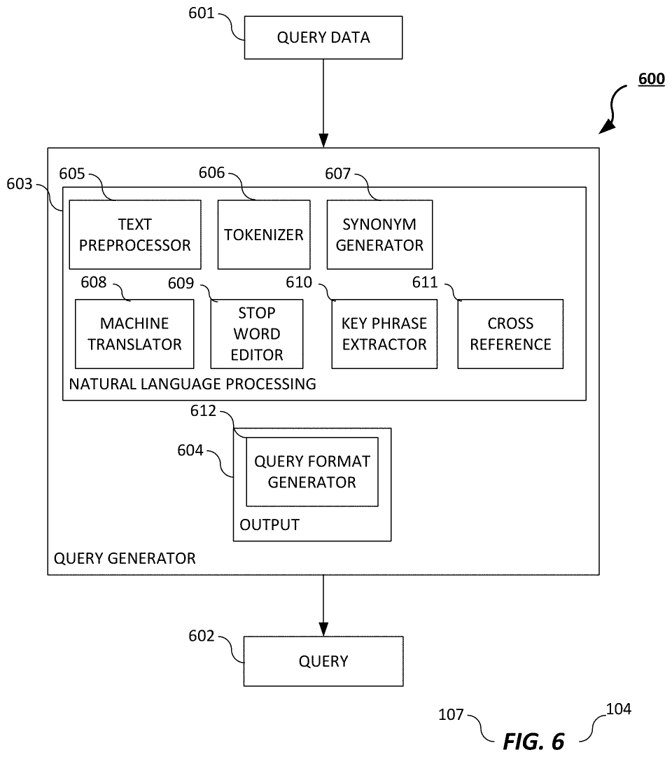

FIG. 6 depicts a query generator 600 in accordance with an embodiment of the disclosed technology. A query generator can take query data 601 and output a query 602. The query generator can comprise a natural language processing module 603, and an output module 604. The query generator is responsible for taking query data and producing a query that is suitable for use in a search engine (described later herein). The query data can comprise metadata about a document. Non-limiting examples of patent metadata include an inventor, prosecuting attorney, national, cooperative, or international patent classification, filing date, priority date, publication date, issue date, among others. The query data can also comprise textual matter from a patent. Non-limiting examples of textual matter include an abstract, specification or a portion thereof, text included in the figures, a claim, and/or a limitation. The query data can also comprise user input, such as user-defined metadata, user-defined textual matter, or a search term or phrase.

In some embodiments, the natural language processing module 603 can process textual matter and/or metadata to produce a portion of the query 602. The natural language processing module 603 can comprise a text preprocessor module 605, a tokenizer module 606, a synonym generator module 607, a machine translation module 608, a stop word editor 609, and a key phrase extractor 610. The text preprocessor module 605 can receive text data and perform preprocessing steps, such as encoding conversion (e.g. ASCII to Unicode), whitespace removal/replacement, removal of invalid or irrelevant characters, and other text data normalization steps. The tokenizer module 606 can tokenize the text data produced by the text preprocessor 605 into lexical units, such as paragraphs, sentences, or words. The synonym generator 607 can analyze textual data and produce a list of relevant synonyms, such as a list of synonyms for words occurring in the textual data in accordance with the techniques for generating synonyms discussed infra, based on the contents of the query data and/or other sources of text, such as standard corpora for a language or corpora derived from a set of patents in the same class, subclass, or related or similar classes, all patent documents, or a set of documents in a similar technical field (such as journal articles, textbooks, product documentation, etc.). By way of a non-limiting example, in some embodiments, the synonym generator 607 can retrieve a set of patents and published patent applications in one or more classes related to a target patent (e.g. the classification of the patent and/or its field of search), build a corpus of text based on the set, and perform a synonym extraction technique on the corpus, such as the vector space/word embedding approach described above. The synonyms generated by the synonym generator 607 can be output to the search engine 700 for use in a synonym list module 712 and/or synonym filter in filters 716.

The machine translator 608 can convert textual matter from a first language to a second language. The key phrase extractor 610 can extract key terms and phrases from the text matter.

In some embodiments, the natural language processing module 603 can process a limitation of a patent claim to generate a query or a portion of a query. In some embodiments, a limitation can be modified by removing a word or phrase from the limitation, such as a stop word or phrase. Examples of stop words or phrases for patent claims include “system,” “method”, “comprising”, “the [system/method] of claim #, further comprising” or others. Examples of stop words and phrases can be computed by analyzing a set of all issued patent claims, and determining the most frequently-occurring words or n-grams, where an n-gram is a sequence of n-words. Extremely high-frequency words and phrases can be used a stop words or phrases, because those words and phrases are not selective, and are likely to generate large numbers of irrelevant results. In some embodiments the limitation can be modified by substituting a word or phrase appearing in an earlier limitation, corresponding specification, or technical thesaurus. In some claims, terms are used that can be extremely rare because they are defined in the specification or in an earlier claim. For such terms, they can be substituted for similar language with similar meaning by parsing earlier claims, or the specification, for occurrences of the term around definition language (e.g. “[term] is a”, “examples of [term] are”, “[term] is defined as”, etc.). In some embodiments, general-purpose or technical thesauruses can be searched for the term, and another term or term from the thesaurus can be substituted for the term.

In some embodiments, the natural language processing module 603 can comprise a cross reference module 611. The cross-reference module 611 is used where the query data contains a plurality of limitations from one or more patent claims. The cross-reference module 611 can determine whether a limitation should be omitted from a query or list of queries because the same or substantially the same limitation has already been provided to the search engine. For example, if a patent includes a plurality of independent and dependent claims, there may be similar limitations between the independent claims or substantially the same dependent claim might depend from multiple independent claims. To avoid unnecessary processing, and to simplify output reports, the cross-reference module 611 can detect such repeated limitations, tag the limitation with a cross-reference referring to one or more other limitations that contain the same text, and/or omit the limitation containing the cross reference from being output as a query 602.

The cross reference module 611 can detect repeated limitations in a plurality of ways. For example, a cross-reference can be detected if two claim limitations are an exact match. Alternatively, the cross reference module 611 can compare the words and their relative frequencies between limitations (either raw words or filtered words that have been lemmatized, stemmed, changed to a standard case, had stop words removed, etc.). If the set of words in one limitation substantially overlaps with the set of words in another limitation, a cross-reference can be detected. A numeric threshold can be set to determine when a cross-reference is found, such as when >80% of the words of two limitations are in common. Another example of cross-reference detection can be based on the concept of edit distances, such as Hamming distance, longest-common-sequence, Levenshtein distance, variants thereof, or other edit distance metric. A cross-reference can be detected when two limitations are within a threshold edit distance of each other, measured in absolute terms, or relative to the limitation length. In some embodiments, any of the above cross-reference detection techniques can be applied either to a raw claim term as it appears in a patent, or to a limitation as processed by text preprocessor 605.

In an example cross-reference detection algorithm implemented by a cross-reference module 611, the limitations of a claim or patent can be sequentially iterated through. For each limitation, the algorithm will attempt to match the current limitation with each prior limitation, in sequential order. If a match is detected, the match is recorded, and no further limitations are evaluated. In this manner, the cross-references read sequentially in order of appearance in a document. If there are no matches, the limitation has no cross-reference. As an optimization, the algorithm can limit comparisons only to those limitations that themselves have no cross reference, thus only looking for matches among unique limitations.

In some embodiments, the output module 604 can take the processed textual matter from the natural language processing module 603 and/or the query data metadata from the query data 601 to produce a search query. The output module 604 can further comprise one or more query format generators 612 that can convert the query generated by the natural language processing module 603 into a format suitable for the search engine. Where multiple search engines are used, an embodiment can have a separate query format generator 612 for each search engine for translating the query into a plurality of formats. The query thus produced can comprise a general query in a generic, or system-specific format. Alternatively, where a query format generator 612 is used with a third-party search engine, the query generator can produce a query in the appropriate format for the targeted search engine.

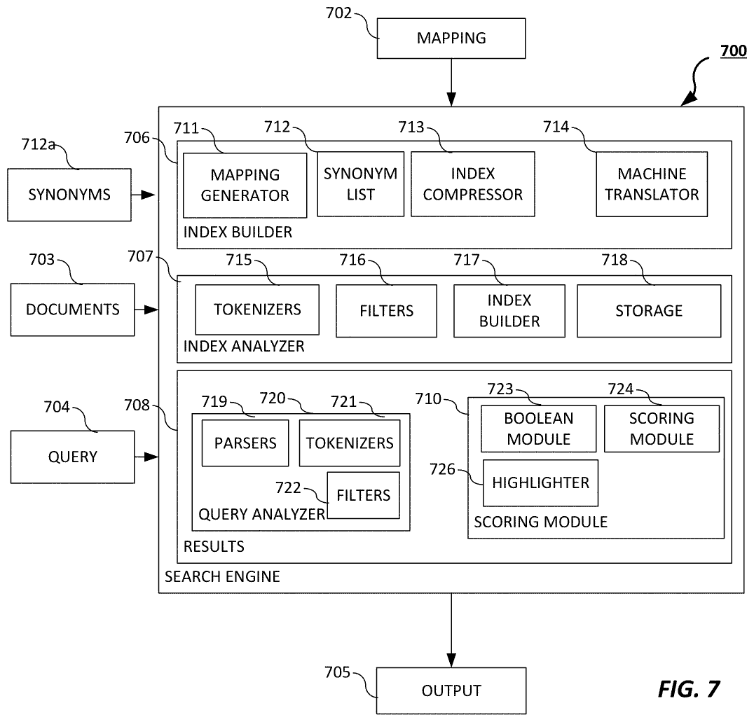

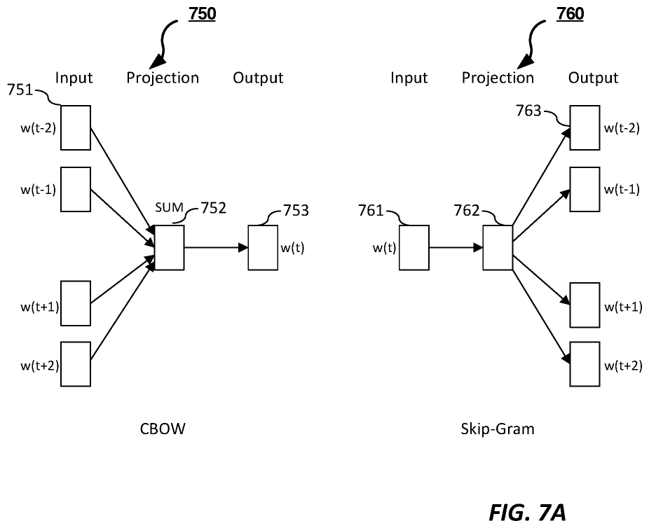

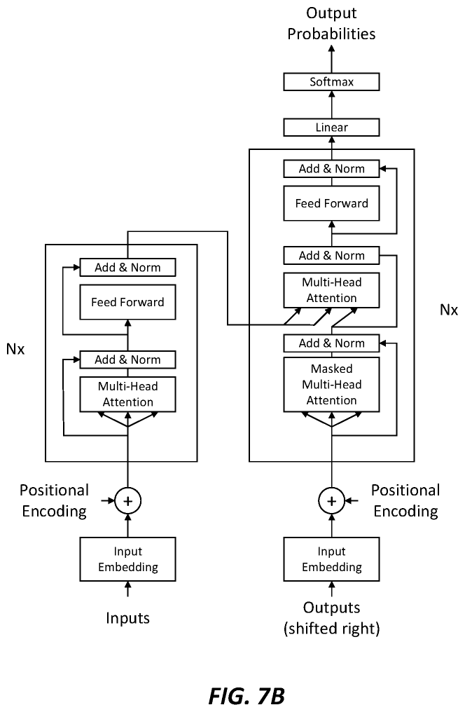

FIG. 7 depicts a search engine module 700 in accordance with an embodiment. The search engine can accept as input mapping data 702, synonyms 712a, search documents 703, and a query 704, and can return an output 705 that can comprise at least a portion of the search document 703 that corresponds to the query 704. The search engine 700 can comprise an index builder submodule 706, an index analyzer submodule 707, and/or a results submodule 708.

One or more portions of the search engine module 700 can be provided by a fulltext search engine, such as Elasticsearch, Apache Solr (both based on Apache Lucene), databases that provide fulltext functionality, such as Postgres or MySQL, among others. Other proprietary information storage and retrieval systems as would be understood by a person of ordinary skill in the art can also be used. Alternatively, a custom search engine can be designed for use with embodiments of the disclosed technology.

The index builder submodule 706 can coordinate the storage of one or more search documents, and provide for general utility services in the search engine. The mapping generator 711 can analyze the mapping data 702 to derive a mapping or schema for search documents 703. The mapping defines a standard format for reading or storing search documents, and should comprise at least one default search field. An example schema is shown in Table 1 below:

TABLE 2
EXAMPLE SEARCH DOCUMENT SCHEMA

| Field Name | Field Description | Examples |
|---|---|---|
| reference | Unique ID for a | “U56045364A” (document number) |
| id | reference | efa54481-2ba4-4638- |
| | | 8cde-9ea5f3539bd1 |
| | | (random identifier) |
| sequence | Sequential counter for | 0 |
| | search documents | 1 |
| | in a reference | 2 |
| citation | Formatted citation | [0001] |
| | to a reference or | col. 5 ll.2-6 |
| | citation data | {“columns”: “5-6”, “lines”: “15-2”} |
| text | Search Text | “A difficult challenge in swing |
| | | intensive sporting activities (e.g., |
| | | golf or tennis) is to perfect a swing |
| | | and repeat it consistently.” |

A search document mapping or schema provides a standard format for analyzing search queries, and a means of validating search documents before inclusion in a search engine. For example, if the sequence identifier is an integer that increments for each sequential portion of a reference, then the search engine can reject a search document with a string as a sequence identifier.

The index builder submodule 706 can further comprise a synonym list module 712. The synonym list module can store a list of synonyms for use in analyzing search documents by the index analyzer 707. In some embodiments, the synonym list module can receive one or more synonym definitions 712a from the synonym generator module 607 of query generator 600. In some embodiments, the synonym list module 712 can also generate a list of synonyms based on the search documents, in accordance with the techniques discussed supra. The synonym list module can store synonym definitions in a variety of formats. For example, the synonym list can store synonym definitions in the Apache Solr-style, as shown below:

| # Blank lines and lines starting with pound are comments.
| # Explicit mappings match any token sequence on the LHS of “=>”
| # and replace with all alternatives on the RHS. These types of mappings
| # ignore the expand parameter in the schema.
| # Examples:
| i-pod, i pod => ipod,
| sea biscuit, sea biscit => seabiscuit
| # Equivalent synonyms may be separated with commas and give
| # no explicit mapping. In this case the mapping behavior will
| # be taken from the expand parameter in the schema. This allows
| # the same synonym file to be used in different synonym handling
strategies.
| # Examples:
| ipod, i-pod, i pod
| foozball , foosball
| universe , cosmos
| lol, laughing out loud
| # If expand==true, “ipod, i-pod, i pod” is equivalent
| # to the explicit mapping:
| ipod, i-pod, i pod => ipod, i-pod, i pod
| # If expand==false, “ipod, i-pod, i pod” is equivalent
| # to the explicit mapping:
| ipod, i-pod, i pod => ipod
| # Multiple synonym mapping entries are merged.
| foo => foo bar
| foo => baz
| # is equivalent to
| foo => foo bar, baz

ElasticSearch Reference 6.3, Synonym Token Filter, available at https://www.elastic.co/guide/en/elasticsearch/reference/current/analysis-synonym-tokenfilter.html. Alternatively, synonyms can be provided as a list of entries in a lexical database, such as WordNet (discussed supra). In some embodiments, the index builder 706 can comprise an index compressor 713 that compresses incoming search documents 703 to minimize the storage space consumed by the search engine 700. In some embodiments, the index builder can further comprise a machine translator module 714 for converting analyzed text from a first language into a second language.

In some embodiments, the search engine 700 can further comprise an index analyzer module 707. The index analyzer module 707 performs preprocessing steps on incoming search documents 703 and putting them in storage 718 to be queried. The index module can comprise one or more tokenizers 715. The tokenizers 715 can take text fields of search documents and divide them into one or more “tokens,” where each token comprises a lexical unit—e.g. a word, sentence, phrase, or paragraph. The tokenizer can also divide an input search document 703 into a plurality of search documents for storage. For example, if a search document contains an unusually long portion of text, the tokenizer can subdivide the search text at sentence boundaries into a plurality of portions, and generate a new search document for each corresponding portion.

In some embodiments, the index analyzer module 707 can further comprise one or more filters 716. Filters are applied to the search documents to transform the text into a format better suited for fulltext searching. Non-limiting examples of filters include stemmer filters, synonym filters, stop word filters, lowercase filters, spelling filters, among others. For example, a lowercase filter converts all letters in the input to lowercase (or, alternatively, an uppercase filter could convert all letters into uppercase). A spelling filter can analyze the input text and correct spelling by identifying words that are misspelled and automatically editing them to the most likely correct word (for example, based on minimum edit distance to possible correct words, or based on Markov probabilities given the word's context). A stop word filter can remove words that commonly occur or have little search value (e.g. “the”, “am”, “comprising,” etc.). Synonym filters can convert words based on a synonym list either by replacing words with a common synonym (e.g. mapping every instance of “vessel,” “cistern,” and “tank” to “tank”), expanding words to contain all their synonyms (e.g. mapping any of “vessel,” “cistern,” and “tank” to “vessel cistern tank”), or combinations of the two. Stemmer filters can remove common prefixes and suffixes in the English language to map various forms of words to the same word. For example, a stemmer can convert “connection,” “connected,” and “connector” to the common “connect.”

In some embodiments, the index analyzer module 707 can further comprise an index builder module 717. The index builder module 717 converts the search documents, in some embodiments as pre-processed by one or more filters 716, and converts them into a data format useful for search. An example of a data format to store search documents is a Vector Space Model (VSM). The VSM represents the text of each search document as one-dimensional vectors of numbers, representing a coordinate in n-dimensional space, where n is the number of unique words in all the text of all stored documents (the “vocabulary” of the search “corpus” of text). For example, if the index builder 717 stored a single document containing the text “I have had a very good day,” the document would be stored in the format:

v=[<i>,<have>,<had>,<a>,<very>,<good>,<day>]

In some embodiments, the VSM can represent a search document where the value of each coordinate is either a 1 or a 0 depending on the presence or absence of the given word in the search document. In this representation, the document would be stored as:

v=[1,1,1,1,1,1,1]

In some embodiments, the VSM can represent a search document where the value of each coordinate is the count of each word in the search document.

v=[1,1,1,1,2,1,1]

In some embodiments, the VSM can represent a search document based on the relative frequency of the term in the search document. In some embodiments, the index builder 717 can store each search document in a manner to facilitate a Term Frequency—Inverse Document Frequency (TF-IDF) search strategy. In such an embodiment, the value of each coordinate is a function of the frequency with which the term occurs in the search document, divided by the frequency the term appears in the entire corpus. In this manner, terms that occur more infrequently are more selective of documents, and generate a larger coordinate value, while terms that occur very frequently in many documents are discounted. For example, where t is the term, d is a search document, and D is the corpus, the value (or “weight”) of a particular coordinate for a particular word is calculated as:

tfidf(t,d,D)=tf(t,d)*idf(t,D)

The functions for tf and idf can take a number of different forms. Examples of each are given in the table below, where f_{t,d} is the count of the selected term in a search document, f_{t′,d} is the count of terms other than the selected term in the search document, K is a user-defined constant, N is the count of all words in corpus, and nₜ is the count of the selected term in a corpus:

TABLE 3
TF AND IDF FUNCTIONS

| Term Frequency (tf) | | Inverse Document Frequency (idf) | |
|---|---|---|---|
| Binary | $\{ \begin{matrix}1 & if term present \\ 0 & if term not present\end{matrix}$ | Unary | 1 |
| Raw count | f_{t,d} | Inverse document | $log \frac{N}{{n}_{t}} = - log \frac{{n}_{t}}{N}$ |
| | | frequency | |
| Term fre- quency | $\frac{{f}_{t , d}}{{\sum }_{{t}^{′}} {f}_{{t}^{′} , d}}$ | Inverse document frequency | $log ( 1 + \frac{N}{{n}_{t}} )$ |
| | | smooth | |
| Log normali- | log (1 + f_{t,d}) | Inverse document | $log ( \frac{{max}_{\{ {t}^{′} ∈ d \}} {n}_{{t}^{′}}}{1 + {n}_{t}} )$ |
| zation | | frequency | |
| | | max | |
| Double normali- zation | $K + ( 1 - K ) * \frac{{f}_{t , d}}{{max}_{\{ {t}^{′} ∈ d \}} {f}_{{t}^{′} , d}}$ | Probabilistic inverse document | $log ( \frac{N - {n}_{t}}{{n}_{t}} )$ |
| | | frequency | |

In some embodiments, the VSM can represent a search document based on a neural network-derived vector, such as a Word2Vec word embedding. In this strategy, a neural network is trained either to predict an omitted word given the words in its surrounding context (“Continuous bag-of-words”) 750, or to predict words surrounding a given word (“Skip-Gram”) 760. For either model, the architecture of the neural network is determined by the context window and the embedding layer size. For example, given a window size of 4 centered on the target word, and an embedding layer size of 100, a Word2Vec model would have as many input nodes as words in the vocabulary, a densely connected layer of as many neural nodes as the embedding layer size, and an output layer having as many output nodes as words in the vocabulary. As an example of training such a model, given the phrase:
The quick brown fox jumped over the lazy dog

A CBOW model would take as the first window “The quick—fox jumped,” and attempt to predict the word “brown,” the second window as “quick brown—jumped over” and attempt to predict the word “fox.” A Skip-Gram model would instead take as the first word “brown” and attempt to predict the phrase “The quick—fox jumped,” etc. This neural network is initially trained on a training corpus of text, which can comprise standard corpora (e.g. the Brown corpus), domains-specific corpora (e.g. U.S. patent publications and grants, or a subset thereof by classification), or across documents provided to a search index implementing such a technique. The result of this training technique is a representative or “embedding” vector for every word in a corpus.

Once these dense embeddings are calculated, each search document can be reduced to a characteristic vector that represents that search document. The embeddings can be converted into such a vector in a number of ways. Some example techniques include summing the vectors for each word in the search document, taking the mean of the vectors for each word in the search document, or taking the mean of vectors for each unique word in the search document. Another such technique can be to take an TF-IDF-weighted average of the vectors for the words in the search document. In this technique, a TF-IDF vector is created, as in any of the TF-IDF techniques as discussed above, to produce a TF-IDF vector for the search document. In such a TF-IDF vector, each dimension represents a word in the input vocabulary. For each entry in the TF-IDF vector, the corresponding dense embedding vector is multiplied by the TF-IDF value, and then summed (or averaged) to produce a characteristic vector.

In some embodiments, other techniques can be used to produce characteristic vectors. For example, a Doc2Vec model can be used. Doc2Vec models are trained in the same manner as Word2Vec models, but take additionally as an input an identifier unique to the document. For example, if the first search document was “The quick brown fox jumped over the lazy dog,” the first CBOW context window would include “<doc #0> The quick—fox jumped,” and the second window would include “<doc #0> quick brown—jumped over,” etc. The embedding vector for the document can then be used directly. Another example is a Sequence2Sequence neural network, such as a transformer model, such as GPT, GPT-2, BERT (Bidirectional Encoder Representations from Transformers), or MT-DNN (Multi-Task Deep Neural Networks). These models directly produce characteristic vectors that can be used in accordance with embodiments of the present disclosed technology.

An example of such a transformer architecture is depicted in FIG. 7B. The encoder is composed of a stack identical layers. Each layer has two sub-layers. The first is a multi-head self-attention mechanism, and the second is a simple, position-wise fully connected feed-forward network. The architecture can further comprise a residual connection around each of the two sub-layers, followed by layer normalization. That is, the output of each sub-layer isLayerNorm(x+Sublayer(x)), whereSublayer(x) is the function implemented by the sub-layer itself.

The decoder is also composed of a stack of identical layers. In addition to the two sub-layers in each encoder layer, the decoder inserts a third sub-layer, which performs multi-head attention over the output of the encoder stack. Some embodiments further comprise residual connections around each of the sub-layers, followed by layer normalization. The self-attention sub-layer is also modified in the decoder stack to prevent positions from attending to subsequent positions.

An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key. In some embodiments, the attention function can be a scaled dot-product attention. The input consists of queries and keys of dimension dₖ, and values of dimension dᵥ. We compute the dot products of the query with all keys, divide each by \sqrt{dₖ}, and apply a softmax function to obtain the weights on the values. This function can be computed on a set of queries simultaneously, packed together into a matrix Q. The keys and values are also packed together into matrices K and V. We compute the matrix of outputs as:

$$Attention ( Q , K , V ) = softmax ( \frac{{QK}^{T}}{\sqrt{{d}_{k}}} ) V$$

Multi-head attention allows the model to jointly attend to information from different representation subspaces at different positions. With a single attention head, averaging inhibits this.

MultiHead(Q,K,V)=Concat(head₁, . . . ,headₙ)W^{O} where headᵢ=Attention(QWᵢ^{Q},QWᵢ^{K},QWᵢ^{v})

Where the projections are parameter matrices Wᵢ^{Q}∈ [symbol] ^{d}^{_{model}}^{×d}^{ₖ}, Wᵢ^{K}∈ [symbol] ^{d}^{_{model}}^{×d}^{ₖ}, Wᵢ^{V}∈ [symbol] ^{d}^{_{model}}^{×d}^{ᵥ}, Wᵢ⁰∈ [symbol] ^{hd}^{ᵥ}^{×d}^{_{model}}.

In some embodiments, the index analyzer module 707 can further comprise a storage module 718. The storage module 718 is a data store that holds search documents 703 once processed by the tokenizers 715 and/or filters 716 to support generating responses to queries. The storage module 718 can comprise a relational or nonrelational database, file-system based storage, or other types of data storage. Where the search documents are stored according to the VSM, the vectors can be stored by the storage module 718.

In some embodiments, the search engine 700 can further comprise a results submodule 708. The results submodule 708 can process a query 704 and return output 705 that can comprise an identification of one or more search documents that match a query 705. In some embodiments, the results submodule 708 can comprise a query analyzer 719. The query analyzer 719 can process queries 704 in the same manner as the index analyzer 707. The query analyzer can comprise a parser 719 to parse a query 704. A query 704 can comprise a plurality of search parameters.

For example, if a mapping contains date fields, the query 704 can comprise a selected date or range of dates. Alternatively, if a mapping contains keyword fields, such as a reference_id or other key term field, the query 704 can comprise one or more keywords to search. The query 704 can further comprise Boolean connectors between keywords, parameters, or ranges, such as “AND”, “OR”, or “NOT.” The query 704 can also contain one or more terms for a full text search. The results submodule 708 can further comprise tokenizers 721 and filters 722 that are functional equivalents of the tokenizers 715 and filters 716 of the index analyzer 707. The tokenizers 721 and filters 722 apply transformations to full text search terms in the same manner that the tokenizers 715 and filters 716 of the index analyzer 707 transform the full text fields of the search documents 703.

In some embodiments, the results submodule 708 can further comprise a scoring module 710. The scoring module processes a query 704 to produce a result comprising at least an identification of one or more search documents 703 and a score that scores how well the one or more search documents 703 match the query 704. The results submodule 708 can comprise a Boolean module 723. In some embodiments, the Boolean module 723 determines whether at least a portion of the search documents 703 are a Boolean match to the non-full-text search parameters of the query. For example, if a parameter is a reference id, then the Boolean module 723 will select only documents that match the reference id to be scored by the rest of the scoring module. In some embodiments, the Boolean module 723 can determine whether a search document is a match for the keyword parameters (e.g. a date is within a range, a keyword matches, the reference_id is the same, etc.)

In some embodiments, the scoring submodule 708 can further comprise a scoring submodule 724 that calculates how well a search document 703 matches a query 704. The scoring submodule 724 can score search documents 708 according to one or more search algorithms. An example of a search algorithm is cosine distance based on the TF-IDF VSM model. A TF-IDF score increases proportionally to the number of times a word appears in the document and is offset by the frequency of the word in the corpus, which helps to adjust for the fact that some words appear more frequently in general. The relevancy score for a search document as calculated in the TF-IDF model is calculated as the cosine distance between the n-dimensional vector represented by a search document and the n-dimensional vector of the search query. Where dₖ is a search document, q is a search query, and wᵢ is the ith coordinate in each vector, the score of a search document is calculated as:

$$cos ( {d}_{j} , q ) = \frac{{d}_{j} ⋆ q}{‖ {d}_{j} ‖ ‖ q ‖} = \frac{{\sum }_{i = 1}^{N} {w}_{i , j} {w}_{i , q}}{\sqrt{{\sum }_{i = 1}^{N} {w}_{i , j}^{2}} \sqrt{{\sum }_{i = 1}^{N} {w}_{i , q}^{2}}}$$

Another relevancy score is the Okpai BM 25 algorithm. BM25 is a bag-of-words retrieval function that ranks a set of documents based on the query terms appearing in each document, regardless of the inter-relationship between the query terms within a document (e.g., their relative proximity). The score based on a BM25 scoring model can be calculated as:

$$score ( D , Q ) = {\sum }_{i = 1}^{n} IDF ( {q}_{i} ) ⋆ \frac{f ( {q}_{i} , D ) ⋆ ( {k}_{1} + 1 )}{f ( {q}_{i} , D ) + {k}_{1} ⋆ ( 1 - b + b ⋆ \frac{\vert D \vert}{avgdl} )}$$

Where f(qᵢ, D) is qᵢ term frequency in the document D, |D| is the length of the document D in words, and avgdl is the average document length in the corpus, and IDF(qᵢ) as

$$IDF ( {q}_{i} ) = log \frac{N - n ( {q}_{i} ) + 0.5}{n ( {q}_{i} ) + 0.5}$$

Where N is the total number of documents in the collection, and n(qᵢ) is the number of documents containing qᵢ.

While some embodiments of the disclosed technology are based on VSM relevancy algorithms, such as TF-IDF or BM25, the disclosed technology is not so limited. Other algorithms that compare the relevancy of a query to a search document can be used in embodiments. Other such algorithms include variants of BM25, such as BM25+ or BM25F, set theoretic modules, such as a standard or extended Boolean model, Fuzzy retrieval, Topic-based Vector Space Models, latent semantic indexing and analysis, probabilistic relevance models, latent Dirichlet allocation, among others.

In some embodiments, such as embodiments that use embedding models or neural networks that produce a characteristic vector, the relevancy score can be computed as the distance between the characteristic vector of the query and the characteristic vectors of each search document in the index. Such a distance can be computed using a variety of metrics, such as Euclidean distance, Manhattan distance, Euclidean distance of L2 normalized vectors, Chebyshev distance, or any other distance metric as known in the art.

In some embodiments the Boolean module can be used in conjunction with, or substituted for a k-nearest neighbors, or approximate k-nearest neighbors module. This module computes a predefined number of nearest neighbors to the search vector, such has the nearest 5, 10, or 20 search documents. Numerous efficient algorithms are known in the art for such k-nearest neighbors approximations, any of which can be used in accordance with embodiments of the present disclosed technology.

In some embodiments, the Boolean module can be omitted altogether, and every search document can be scored relative to the query 704.

In some embodiments, the Boolean module 723 and/or the scoring module 724 can be used to compute a set of results to the query 704 for output 705. The Boolean module can search the collection to produce a set of search documents for documents that are a positive match for the keyword/non-fulltext search parameter. The scoring module 724 can then compute a relevancy score for each search document identified by the Boolean module 723 according to the methodologies above. The search documents can also be ranked by the scoring module 724 according to the relevancy score prior to being returned as output 705.

In some embodiments, the scoring submodule 710 can further comprise a highlighter module 726. The highlighter module 726 can return at least a portion of a scored search document 703, where the portion comprises the portions of a search document that contribute to the score of the document—such as the presence of a term that is similar (e.g. a synonym, has a common stem or lemma, etc) to a term in the full text parameter of a search query. In some embodiments, the highlighter module 726 can return a portion of the search document with one or more words emphasized, e.g. by tagging them with a hypertext <b>, <i> or <strong> tag, or the like. The highlighter module can annotate, or add to the results obtained by the scoring submodule 710 the highlights before returning the set of results, along with highlights, as output 705.

In some embodiments, the output 705 can comprise one or more of the maximum relevancy score from the query, the relevancy score for a plurality of search documents, one or more fields of one or more search documents, and/or one or more highlights of a full text field of a search document.

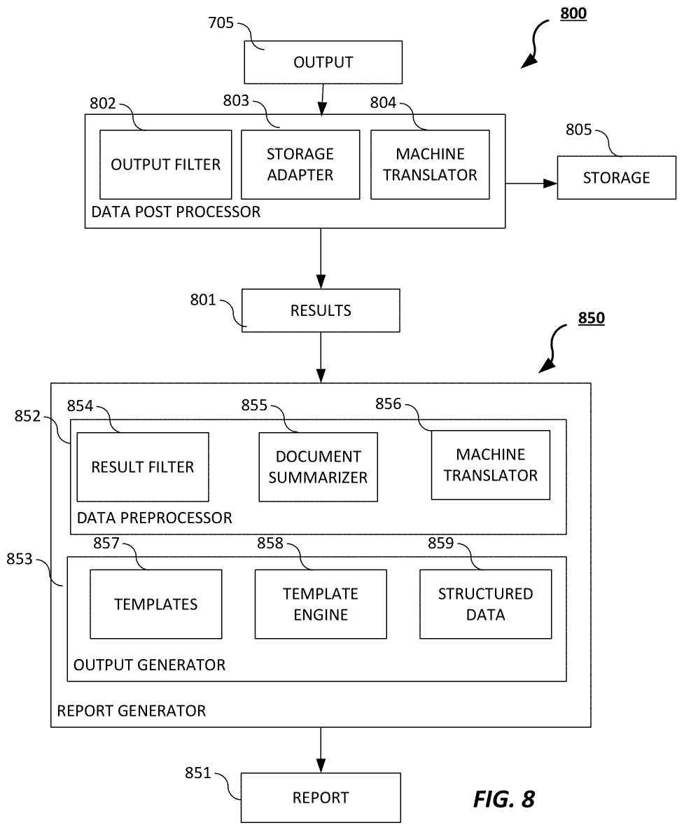

FIG. 8 depicts a data post processor 800 and a report generator 850 in accordance with an embodiment. The data post processor 800 can receive the output 705 from the search engine 700 and adapt the data for further processing by outputting results 801 to a report generator 850 and/or outputting data to one or more storage systems 805. The data post processor 800 can comprise one or more output filters 802, one or more storage adapters 803, and a machine translation module 804. The output filters 802 can convert the results from one format to another, such as by the extraction, deletion, or transformation of various components of output 705 (e.g. only returning the top n results, only returning the maximum relevancy score, number of matching documents, or combining the text of top n search documents, or annotating search documents with adjacent search documents in the source reference to provide context). The data post processor 802 can further comprise one or more storage adapters 803 for outputting data to one or more storage systems 805. For example, a storage adapter can be a module configured to transform result data into an SQL INSERT command to a relational database, a properly formatted PUT or POST request to a REST API, output to a file format on a local or networked file system, etc. The data post processor 800 can further include a machine translator module 804 for converting the output of the search engine 705 (in some embodiments, as processed by one or more output filters 802) from a first language into a second language. The data post processor 800 can also return the results 801 of the data post processor 800 as applied to the output 705 of the search engine 700 to a report generator 801. In some embodiments, the data post processor can be omitted, and the output 705 of the search engine 700 can be sent directly to the report generator 850.

The report generator 850 can produce one or more reports 851 that correlate one or more limitations and/or one or more claims of a patent to one or more references. The report generator takes the output 705 of the search engine 700 or the results 801 from a data post processor 800, and produces one or more reports 851. The reporting module can comprise a data preprocessor module 852 and an output generator 853.

The data preprocessor module 803 can comprise one or more result filter 805, a document summarizer 806, and a machine translator 807. The one or more result filters 705 can filter or transform the results 801 into a format suitable for producing reports. By way of non-limiting example, if the selected report is a spreadsheet of the maximum relevancy score for the search documents in each reference of a plurality of references, the result filters 705 can remove other output, such as the search documents themselves, highlighting, etc. By way of other non-limiting example, the data preprocessor module 803 can compute the mean, weighted average, or other metric of the relevancy score of the top n search documents.

In some embodiments, where the report is a report relating to the combined relative match of a plurality of search documents, such as potential obviousness combinations, or selections of infringement/patentability documents to include in a chart or other work product, the result filter 854 can combine portions of the results 801 to produce other results. By way of non-limiting example, the composite match of a plurality of references can be computed by combining a relevancy metric for each reference for each limitation. An example of this would be to calculate the maximum relevancy score for each limitation in one or more patent claims across a plurality of references, or to compute the mean or weighted average of the maximum relevancy score for the plurality of references, among other calculations.

In some embodiments, the data preprocessor 852 can include a document summarizer 855 for summarizing natural language in a search document or other text. For example, given a set of highlights and a search document, the document summarizer 855 can summarize the search document by tokenizing the search document into a plurality of lexical units, and then returning only the lexical units included in the highlights, or a subset thereof, possibly as joined by some connector. By way of non-limiting example, if the highlights consist of single words or short phrases, the document summarizer 855 can tokenize the search document into sentences, and then return only those sentences that contain the highlighted words or phrases, optionally connected by ellipses. By way of another non-limiting example, if the highlights consist of full sentences that appear in the search document that match a query, the document summarizer can arrange the full sentences in the order they appear in the search document, optionally connected by ellipses.

In some embodiments, the document summarizer 855 can summarize other textual matter for inclusion in a report. For example, the document summarizer can generate a computer-generated summary of the specification, claims, or a portion of either of a reference. An example of a document summarization system in accordance with an embodiment is described in U.S. Pat. No. 7,607,083, entitled “Text Summarization Using Relevance Measures and Latent Semantic Analysis,” the entirety of which is incorporated by reference as if fully set forth herein. As would be recognized by a person of ordinary skill in the art, other summarization methodologies can be used, both those now-known and later-developed.

The data preprocessor 852 can further include a machine translation module 856 for translating textual matter from a first language to a second language. The machine translation module 856 can translate all or a portion of the results 801 (optionally as filtered by one or more result filters 854), and/or the results of the document summarizer 855.

The output generator 804 can comprise one or more templates 808, one or more template engines 809, and one or more structured data generators 810. In some embodiments, the output generator can be based around a template engine 858 which places data into a format defined by one or more templates 857. The templates can consist of plaintext or structured data that include markers that indicate where in the template various components of data output by the data preprocessor 852. The one or more template engines 858 then combines the one or more templates 857 with the output of the data preprocessor 852 (or directly the results 801 of the data post processor 800 or the output 705 of the search engine 700) to produce one or more reports 851.

In some embodiments, the output generator 804 can comprise one or more structured data modules 859 for converting the output of the data preprocessor 852 (or directly the results 801 of the data post processor 800 or the output 705 of the search engine 700) into a structured data format directly for output, without a template.

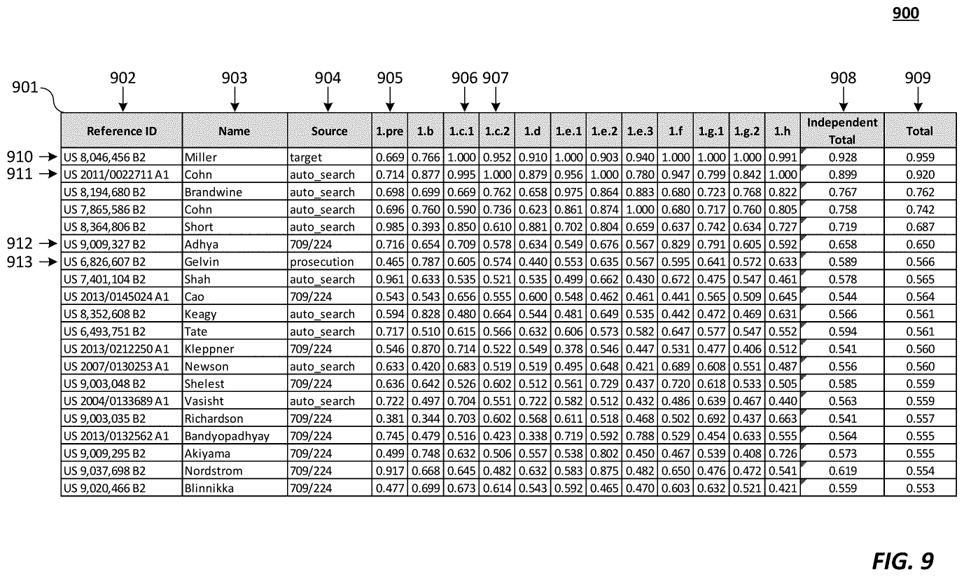

FIGS. 9-11 depict example reports in accordance with embodiments. FIG. 9 depicts a chart comparing a plurality of references against a patent. The report can comprise a table 901, with columns that indicate a reference identifier 902. The report can further comprise tables that contain bibliographic data about each reference, such as a short name 903, (e.g. the last name of the first-named inventor), and can include other data, such as a filing date, priority date, assignee, classification, etc. The table 901 can further comprise a column that denotes a source 904 indicating where the reference was located. Example sources are the targeted patent (denoted here as “target”), an automated prior art searcher (denoted here as “auto_search”), members of a classification of patents, such as a USPC classification (an example here is class 709/224), references cited during prosecution of the target reference (denoted here as “prosecution”). The table can further comprise columns that indicate how well a reference matches against a limitation of a claim in a target patent 905. In Table 901, columns are listed for each limitation of claim 1 of target patent U.S. Pat. No. 8,046,456 B2, indicated as 1.pre to 1.h.

In some embodiments, individual limitations can be further subdivided into sub-limitations, as shown for sub-limitations 1.c.1 (906) and 1.c.2 (907). Occasionally, limitations of claims will be extremely lengthy, and will contain multiple “wherein” or other explanatory clauses. For example, limitation 1.c of U.S. Pat. No. 8,046,456 is:
receive configuration information from the client to configure a computer network provided for use by the client, the configuration information indicating interconnections between multiple computing nodes of the provided computer network that include one or more networking devices;

This limitation can produce inadequate search results due to the number of terms that would be included in a generated query. To address this challenge, the explanatory phrase that begins “the configuration information indicating . . . ” can be split, to produce two smaller limitations. The limitation can be split on phrases that appear to suggest a further explanation or detailed limitation, such as a comma, or the phrases “, the” or “, wherein”. For example, the imitation 1.c can be divided into 1.c.1 and 1.c.2 on the phrase “, the”:
receive configuration information from the client to configure a computer network provided for use by the client,
the configuration information indicating interconnections between multiple computing nodes of the provided computer network that include one or more networking devices;

In some embodiments, a corresponding query report can be produced that illustrates how a system in accordance with an embodiment sub-divided the limitations of a targeted patent limitation, and what queries were generated based on those limitations. The table below illustrates the subdivided limitations and corresponding queries for limitations 1.pre-1.d in table 901:

TABLE 4
LIMITATIONS & GENERATED QUERIES

| Number | Limitation | Search Query |
|---|---|---|
| 1.pre | A computing system, comprising | a computing system comprising |
| 1.a | one or more processors | |
| 1.b | and a manager module that is | a manager module that is executed |
| | configured to, when executed | by processors and for clients |
| | by at least one of the processors, | |
| | and for each of one or more clients | |
| 1.c.1 | receive configuration information from | receive configuration information from |
| | the client to configure a computer | the client to configure a computer |
| | network provided for use by the client | network provided for use by the client |
| 1.c.2 | configuration information | configuration information indicating |
| | indicating interconnections | interconnections between |
| | between multiple computing nodes | multiple computing nodes of the |
| | of the provided computer network that | provided computer network that |
| | include one or more networking devices | include networking devices |
| 1.d | automatically configure | automatically configure the provided |
| | the provided computer network | computer network for the client in |
| | for the client in accordance with the | accordance with the received |
| | received configuration information, by | configuration information by |

As shown in the table above, the “Limitation” lists the full text of each limitation. As previously discussed, some limitations, such as 1.c, are subdivided into smaller limitations, such as 1.c.1 and 1.c2 shown above. The Search Query column illustrates the fulltext parameters for a query corresponding to the limitation, as generated by the query generator 600. By way of non-limiting example, terminology that is not helpful to queries, such as “a processor” or “one or more of” are deleted from the limitations, resulting in an empty query for limitation 1.a. Where the result of simplification results in a null query, such as for basic preambles (e.g., “a method, comprising”, or “The system of claim 1, further comprising”) or generic limitations (“one or more processors”), the limitation can be omitted from the report, as is shown in table 901.

Alternatively, limitations 1.b. is simplified to eliminate the phrase “configured to,” and “at least one of the” and “for each one of the.” Those search terms occur with great frequency in patent documents and are unlikely to produce valid results. The result is that limitation 1.b has a simplified search query that is simply “a manager module that is executed by processors and for clients.”

The score indicated in each cell can be computed in a number of ways. In some embodiments, the set of search documents correlating to a reference are searched, using a query based on a claim limitation, to retrieve a set of results. The score indicated in the table can be the relevancy score of the highest-scoring search document—indicating the best possible disclosure in the reference of that limitation. Alternative methodologies can include taking the average of the top n scoring references, or computing a weighted average of the top n scoring references, giving greater weight to higher scoring references. Further, the result of a scoring methodology can be normalized to fit within a discrete range, such as 0-1, or 0-100, according to the normalization formulae discussed infra. In the non-limiting example table 901, the scores for each limitation are computed as the relevancy score of the top-ranked search document in each reference, normalized to a range of 0-1 based on the maximum score for that limitation across all references. The rows of table 901 are then ordered by descending total score 909.

To score the overall match of a reference to the claims of a targeted patent, a computed total score can be included as a column. An overall total score 909 can include the scores of each scored limitation of the targeted patent, while an overall independent total score 908 can include only the scores of limitations of independent claims in the targeted patent.

In the example table 901, a row 910 in the table indicates data for the targeted patent. This row has a reference ID of “U.S. Pat. No. 8,046,456 B2” and the name “Miller.” The source field 904 of row 910 indicates that this row is the targeted patent. As is shown in table 901, the targeted patent is often the highest-ranked reference, as the targeted patent is required to provide adequate support for each limitation of each claim. By including the targeted patent in the table 901, the comparative match quality of other references can be determined relative to the targeted patent. Experience has shown that references are likely to invalidate a targeted patent if the score of the reference is greater than about 70%, with higher scores being correlated with references (or combinations) more likely to invalidate a reference.

In the example table 901, a row 911 in the table indicates data for a reference identified by an automatic searching algorithm, such as a search conducted by a reference search module 400. As shown in the table 911, this row 910 represents the best match for the targeted patent, and thus the most likely reference to invalidate the targeted patent by anticipation.

In the example table 901, a row 912 in the table indicates data for a reference in a selected USPC classification, in this instance, class 709/225—“computer network access regulating.” The targeted patent also is in USPC class 709/225, thus suggesting that relevant prior art may be found in that same class. Examining the classification entry, the USPC also recommends that relevant art may be found in subclass 709/228, or in other classes 340, 710, 713, and 717. Due to the relative ease of scoring a single reference, embodiments can score all or a portion of each class, recommended search classes, or the “field of search” of a patent. In some embodiments, the scoring of other references is can be limited to only those references that qualify as prior art to the targeted patent under applicable statutes.

In the example table 901, a row 913 in the table indicates data for a reference cited during the prosecution of the targeted patent, labeled as “prosecution.” By including references cited during prosecution in the scoring process, embodiments of the system can identify art that is comparatively more relevant than that cited during prosecution, or alternatively gauge how effective the examination was conducted. References that score more highly than the references cited during prosecution are more likely, for example, to invalidate the targeted patent in subsequent litigation or patent office challenges (e.g. IPR's or reexaminations).

The table 901 can further be used to evaluate potential combinations of references that may tend to invalidate a targeted patent. For example, reference US 2011/0022711 A1 to Cohn, while a good match, does not have a particularly high score for limitation 1.e.3, which reads:
overlaying performed to enable multiple communications between the multiple computing nodes to be forwarded over the second computer network without physically providing the one or more networking devices

However, both U.S. Pat. No. 8,194,680 B2 to Brandwine and U.S. Pat. No. 7,865,586 B2 to Cohn (“Cohn II”) both have higher scores for limitation 1.e.3. Thus, it is likely that if the claims of the targeted Miller patent are not anticipated by Cohn, they may instead be invalid as obvious (or for lack of inventive step), over Cohn in view of Brandwine, or Cohn in view of Cohn II.

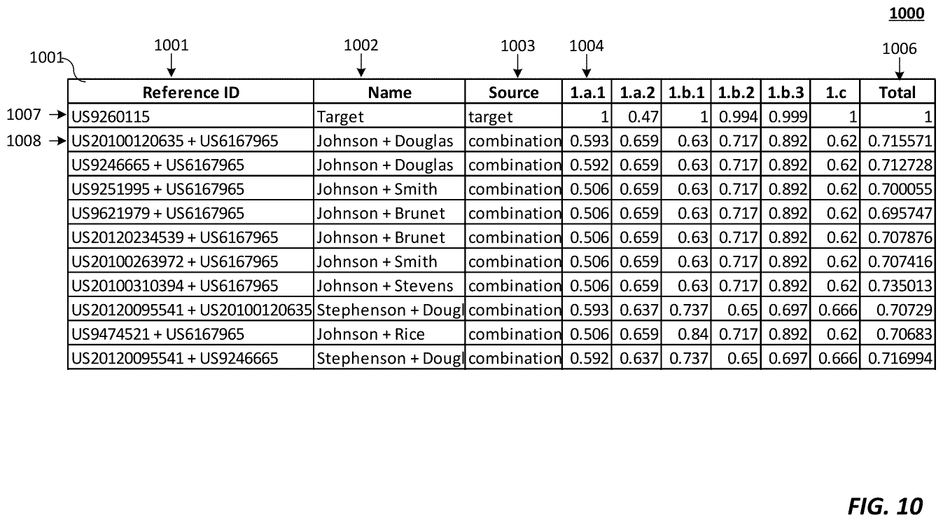

FIG. 10 depicts a report 1000 in accordance with an embodiment that compares combinations of references to a plurality of limitations of a targeted patent. The present disclosed technology can further be used to quantitatively evaluate potential combinations of references. For example, an additional row can be added to table 901 to include such combinations, where the score for each limitation is some combination of the scores for each limitation for each reference in the combination. Alternatively, a report 1000 can be produced by embodiments that quantitively compares combinations of references. The report 1000 includes a table 1001, similar to table 901. Each row in table 1001 illustrates the scores of a particular combination of references. The combinations can be specified by a user, or automatically generated as combinations of a set of references. In some embodiments, the combinations can be automatically generated as combinations of the set of references having the top n score for each limitation in a plurality of limitations (i.e. the top n highest scoring references for each individual limitation).

Each row can include columns for reference ID 1001 that lists the reference IDs of a plurality of references in a particular combination, one or more reference data column, such as reference names 1002 (here, the first named inventor of each reference), or the source/type of combination 1003. Columns can also include any other form of reference data for the references in the combination illustrated by each row, such as classification, priority, filing, issue, or publication dates, etc. The reference data can be combined in several ways, such as by joining them by a separator (e.g. “+”), or, if a date is used, the earliest or latest date, or if the references belong to a common class, but are in separate subclasses, the shared class.

The table 1001 can further include a plurality of columns 1004 for each limitation in the claims of the patent, here abbreviated to show only the limitations of claim 1. The scores can be combined by, for example, taking the mean of the two scores, or using the highest score of the two scores, among other measures for combining the scores of each individual reference. Combinations can then by analyzed and compared among other combinations, or can be compared to the scores for individual references. For example, table 1000 includes a row showing the results for a targeted patent, and for a combination of references.

Other possible column types include a “combination leverage” score which calculates the comparative contribution of the various references. For example, in obviousness combinations, there is typically a primary reference that discloses a majority (or plurality) of limitations, and one or more other secondary references to address the deficiencies in the primary reference. The combination leverage can then be calculated as the percentage of limitations for which the primary reference has the maximum score, over the total number of limitations (the rest being contributed by one or more secondary references). Leverage scores can also be calculated for the other references in the combination as the total number of limitations in that reference divided by the number of references. Combination leverage scores can give a quantitative measure for the persuasiveness of a combination, where higher leverage scores indicate that the primary reference contributes most of the limitations, and thus does not need to rely as heavily on the other references.

The table 1000 illustrates a target reference on row 1007 as compared to a plurality of combinations. As shown here, the Target has an overall score of 1, having the highest total score among the scored limitations. In some embodiments, columns 1004 can be included for the limitations of multiple claims or of all claims in the patent, and subtotals calculated for the total score for all independent claims, each independent claim, each family of claims (e.g. an independent and its dependents) among other measures. Here, the best combination is Johnson, in view of Douglas on row 1008, which has a composite score of 0.715571. This score represents the relative strength of the combination. As with FIG. 9, experience has shown that combinations with scores over 0.7 are typically good candidates for invalidity combinations.

While FIG. 10 depicts a report in accordance with an embodiment for invalidity/patentability purposes, embodiments of the disclosed technology also include infringement/noninfringement combinations, which score the relative strength of combining a plurality of references to show that a patent is infringed. Combination scores in the infringement context can assist a user in locating a subset of references to include in a chart, memo, opinion letter, brief, of other work product to illustrate the infringement or noninfringement of limitations of a patent.

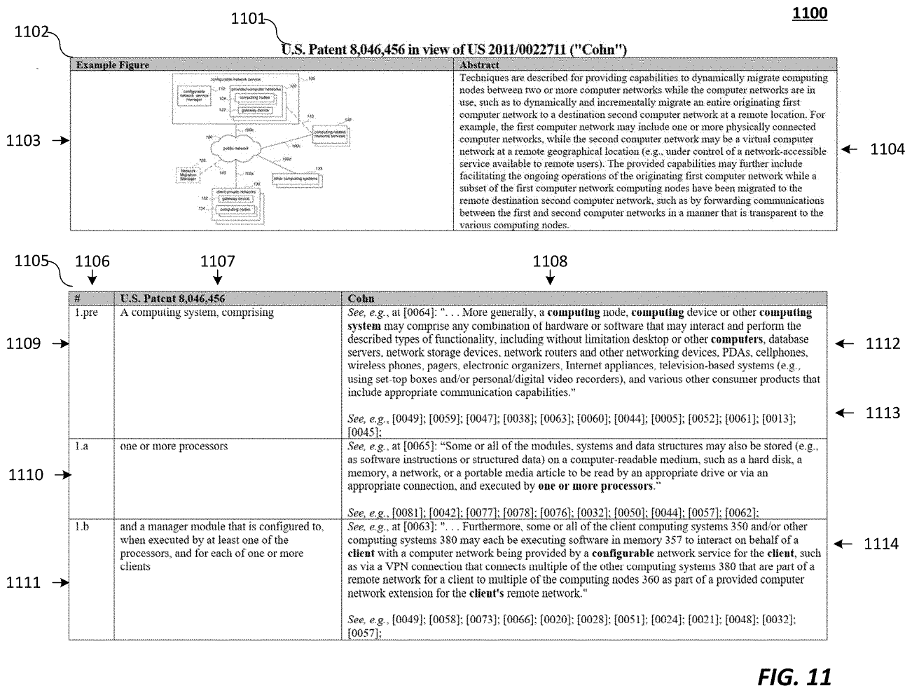

FIG. 11 depicts an example claim chart 1100 illustrating the invalidity of a patent in view a reference. The chart 1100 is a chart intended to ease human review of the results provided by embodiments of the disclosed technology. The chart 1100 can comprise a title 1101 that indicates the targeted patent (U.S. Pat. No. 8,046,456) and the references against which the reference is analyzed (US 2011/0022711 to Cohn). The chart 1100 can further comprise a summary table 1102 that provide a brief overview of the analyzed reference (here, the Cohn reference). The summary table can comprise an example FIG. 1101, the abstract of the disclosure 1104, as well as other general information about the reference, such as filing date, application status, classification, priority claims, or other generated information, such as a machine-produced summary of the disclosure.

The chart 1100 can further include a claim chart 1105 that compares the claims of the target patent to a reference. The claim chart 1105 can include columns for the limitation number 1106, the limitation text 1107, and/or the matches in the reference 1108. Other possible columns include the query generated by the query generator 600. Columns can also be combined, such as putting the limitation number in the same column as the limitation text.

Chart 1100 includes a row for limitations in the targeted patent. The example chart 1100 includes limitations 1.pre through 1.b in rows 1109-1111. Each result row can include one or more quotation results 1112, and one or more citation results 1113. Because this chart is intended to aid human review, each quotation result and/or citation result is listed in relevancy order. A human viewing row 1109 can therefore see that the most relevant disclosure in Cohn for the limitation “A computing system, comprising” occurs in paragraph [0064], and that the next most relevant disclosure is in paragraph [0081].

In some embodiments, quotation hits 1112 can include the entirety of the text for the search document to which the quotation hit corresponds. In some embodiments, the quotation hits can be summarized by document summarizer 855. In some embodiments, the quotation hit can be abbreviated, such as by eliminating sentences or phrases that did not contribute to the match. Quote hit 1114 is an example of this, showing that material from the search document was omitted at the beginning of the hit by ellipses “ . . . .” Material can be omitted at the beginning, end, or in the middle of a quote hit. In some embodiments, certain words or phrases in a quote hit can be emphasized, such as words or word forms that co-occur between the limitation and the quote hit. For example, in row 1112, the words “computing” and “computer” are bolded, because the word “computing” appears in the corresponding limitation.

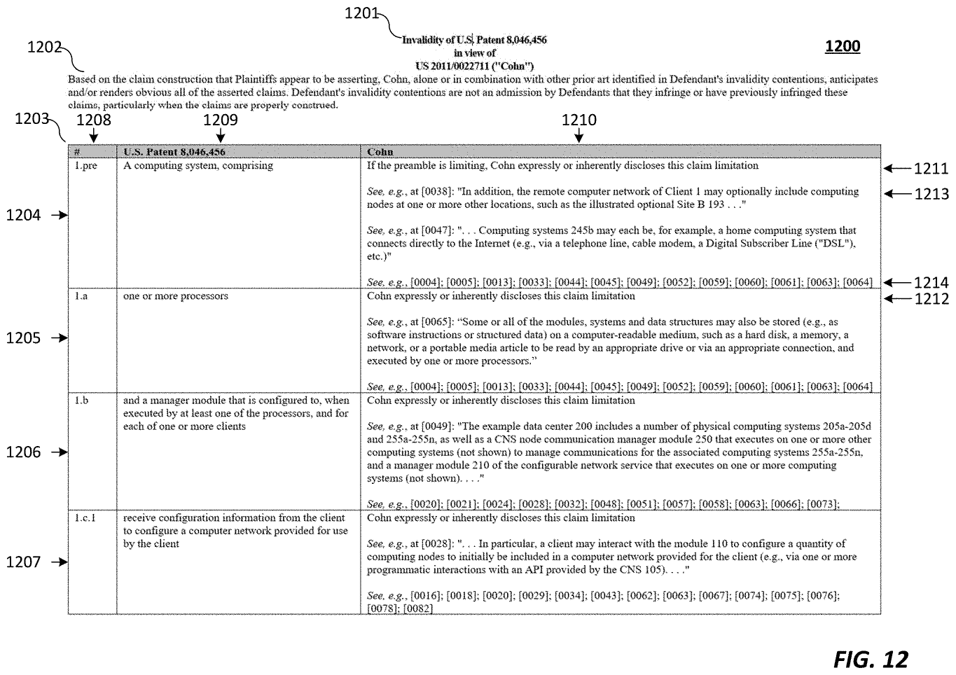

FIG. 12 depicts an example invalidity contention 1200 of a patent in view of a reference in accordance with an embodiment. The invalidity contention 1200 is a chart in a format intended for litigation, to be exchanged with opposing counsel to show where in each reference the limitations of the targeted patent are infringed, or filed with the court. The invalidity contention 1200 includes a title 1201 which indicates the targeted patent and the charted reference. The chart can further include an explanatory paragraph 1202 that expressly indicates that the chart is dependent on the results of claim construction, can be used for purposes of either anticipation or obviousness/inventive step, and that nothing in the chart is an admission that any limitation is infringed by a defendant. The chart can further includes a claim chart 1203 that maps each limitation to the reference. The example chart 1200, like the claim chart 1105, can include columns for the limitation number 1208, patent number 1209, and/or the match information 1210, and include rows 1204-1207 for each limitation. Each match information cell in column 1210 can include preamble disclaimer language 1211 and limitation disclaimer language 1212. The preamble disclaimer 1212 expressly states that, if the preamble is limiting, it is taught by the charted reference. Similarly, the limitation disclaimer 1212 expressly states that each limitation is taught by the charted reference.

The match data column 1210 of the claim chart 1203 can contain quote hits 1213 and cite hits 1214, similarly to chart 1105. In contrast, however, the quotation hits 123 and citation hits 1214 are put in order of appearance in the reference. That is, for each hit in the search documents for a reference, the top portion of the hits are selected for quote hits, and are placed in chronological order in the quote hits 1213, and then the next portion of the hits are selected for citation hits, and are placed in chronological order in the citation hits 1214.

The charts described in FIGS. 11-12 map a single reference against a targeted patent in accordance with an embodiment. However, the present disclosed technology is not so limited. Instead, reports that compare the claims of a targeted patent to a plurality of references are also expressly contemplated. For example, each match data cell could include a separate section for at least a portion of the charted references (e.g. the top references for that limitation). Likewise, reports need not include quotation hits, and can instead merely list citations to a plurality of references.

The reports described in FIGS. 9-12 are illustrative of embodiments of the disclosed technology intended to show validity or invalidity. However, the technology disclosed herein is not limited merely to invalidity or validity. The term “reference” as used herein can include documents that are not necessarily prior art to a reference. For example, if a device is accused of infringement, references can be documents that describe the functionality of the accused device, such as user manuals, internet or magazine articles, marketing materials, design drawings and documentation, etc. In that context, similar reports can be generated to show the infringement or non-infringement of the claims of a patent by comparing infringement references to the limitations of a targeted patent. Such infringement and non-infringement embodiments are expressly within the scope of the invention contemplated herein.

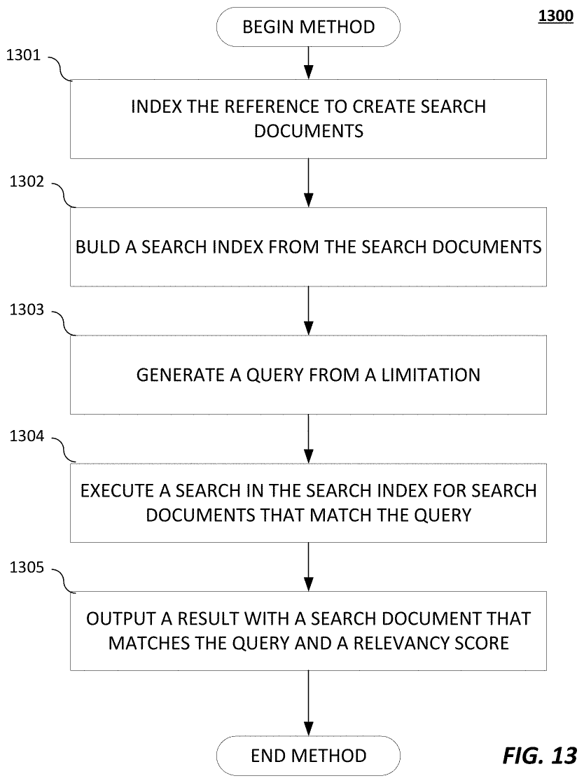

FIG. 13 depicts a flowchart for a method 1300 in accordance with an embodiment. A method in accordance with an embodiment can comprise a step 1301 of indexing the reference to create a plurality of search documents. The method can further include the step 1302 of building a search index from the plurality of search documents. The method can further include the step 1303 of generating a query from the limitation. The method can further include the step 1304 of executing a search in the search index for search documents that match the query. The method can further include the step 1305 of outputting a result, comprising a search document that matches the query and a relevancy score representing a relevancy of the search document to the query.

The flowchart and/or block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Any flow diagrams depicted herein show just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for analyzing whether a reference describes a limitation of a patent claim by a computing device, the method comprising:
indexing the reference to create a plurality of search documents;
building a search index from the plurality of search documents;
generating a query from the limitation;
executing a search in the search index for search documents that match the query; and
outputting a result, comprising a search document that matches the query and a relevancy score representing a relevancy of the search document to the query.

2. The method of claim 1, wherein indexing the reference further comprises:
splitting the reference into a plurality of lexical units, and creating a search document that contains a set of fewer than all lexical units in the reference.

3. The method of claim 2, wherein creating a search document that contains fewer than all the lexical units in the reference further comprises:
generating a citation for each search document that refers to the location within the reference of the set of the fewer than all lexical units in the reference.

4. The method of claim 1, wherein generating a query further comprises:
modifying the limitation by removing a word or phrase from the limitation and substituting a word or phrase appearing in an earlier limitation, corresponding specification, or technical thesaurus.

5. The method of claim 1, further comprising:
outputting a chart that contains the limitation, and a citation corresponding to the location of the matching search document within the reference.

6. The method of claim 1, wherein the step of outputting a result further comprises a plurality of highlighted portions of the search document that matches the query, the method further comprising:
outputting a chart that contains the limitation, and a summary of the matching search document;
wherein the summary of the matching search document is prepared by connecting the highlighted portions of the search document in the order they appear in the search document.

7. The method of claim 1, further comprising:
selecting the reference from a plurality of references by executing a second query in a search engine containing the plurality of references, wherein the second query comprises a keyword extracted from a claim containing the limitation.

8. A system for determining where in a plurality of references a limitation of a patent claim is described by a computing device, the system comprising:
one or more memories having computer readable computer instructions; and
one or more processors for executing the computer readable computer instructions to perform a method comprising:
indexing the reference to create a plurality of search documents;
building a search index from the plurality of search documents;
generating a query from the limitation;
executing a search in the search index for search documents that match the query; and
outputting a result, comprising a search document that matches the query and a relevancy score representing a relevancy of the search document to the query.

9. The system of claim 8, wherein indexing the reference further comprises:
splitting the reference into a plurality of lexical units, and creating a search document that contains a set of fewer than all lexical units in the reference.

10. The system of claim 9, wherein creating a search document that contains fewer than all the lexical units in the reference further comprises:
generating a citation for each search document that refers to the location within the reference of the set of the fewer than all lexical units in the reference.

11. The system of claim 8, wherein generating a query further comprises:
modifying the limitation by removing a word or phrase from the limitation and substituting a word or phrase appearing in an earlier limitation, corresponding specification, or technical thesaurus.

12. The system of claim 8, wherein the computer readable computer instructions further comprise:
outputting a chart that contains the limitation, and a citation corresponding to the location of the matching search document within the reference.

13. The system of claim 8, wherein the step of outputting a result further comprises a plurality of highlighted portions of the search document that matches the query, the method further comprising:
outputting a chart that contains the limitation, and a summary of the matching search document;
wherein the summary of the matching search document is prepared by connecting the highlighted portions of the search document in the order they appear in the search document.

14. The system of claim 8, wherein the computer readable computer instructions further comprise:
selecting the reference from a plurality of references by executing a second query in a search engine containing the plurality of references, wherein the second query comprises a keyword extracted from a claim containing the limitation.

15. One or more non-transitory computer-readable storage medium containing machine-readable computer instructions that, when executed by a processing device, perform a method of determining where in a plurality of references a limitation of a patent claim is described by a computing device, the method comprising:
indexing the reference to create a plurality of search documents;
building a search index from the plurality of search documents;
generating a query from the limitation;
executing a search in the search index for search documents that match the query; and
outputting a result, comprising a search document that matches the query and a relevancy score representing a relevancy of the search document to the query.

16. The one or more non-transitory computer-readable storage medium of claim 15, wherein indexing the reference further comprises:
splitting the reference into a plurality of lexical units and creating a search document that contains a set of fewer than all lexical units in the reference.

17. The one or more non-transitory computer-readable storage medium of claim 16, wherein the instructions for creating a search document that contains fewer than all the lexical units in the reference further comprises:
generating a citation for each search document that refers to the location within the reference of the set of the fewer than all lexical units in the reference.

18. The one or more non-transitory computer-readable storage medium of claim 16, wherein generating a query further comprises:
modifying the limitation by removing a word or phrase from the limitation and substituting a word or phrase appearing in an earlier limitation, corresponding specification, or technical thesaurus.

19. The one or more non-transitory computer-readable storage medium of claim 15, wherein the machine-readable computer instructions further comprise:
outputting a chart that contains the limitation, and a citation corresponding to the location of the matching search document within the reference.

20. The one or more non-transitory computer-readable storage medium of claim 15, wherein outputting a result further comprises a plurality of highlighted portions of the search document that matches the query, the method further comprising:
outputting a chart that contains the limitation, and a summary of the matching search document;
wherein the summary of the matching search document is prepared by connecting the highlighted portions of the search document in the order they appear in the search document.

21. The one or more non-transitory computer-readable storage medium of claim 15, wherein the machine-readable computer instructions further comprise:
selecting the reference from a plurality of references by executing a second query in a search engine containing the plurality of references, wherein the second query comprises a keyword extracted from a claim containing the limitation.
